(19) United States
(12) Patent Application Publication
(10) Pub. No.: US 2025/0063638 A1
(43) Pub. Date: Feb. 20, 2025

(54) SYSTEMS, METHODS, AND DEVICES FOR SURFACE RESISTIVITY OPTIMIZATION FOR DEICING AND DEFOGGING

(71) Applicant: Betterfrost Technologies Inc., Oakville (CA)

(72) Inventors: Sameh M. I. Saad, Stoney Creek (CA); Ahmed Sheir, Brampton (CA); Derrick Redding, Ann Arbor, MI (US)

(21) Appl. No.: 18/808,766

(22) Filed: Aug. 19, 2024

Related U.S. Application Data
(60) Provisional application No. 63/520,209, filed on Aug. 17, 2023.

(51) Int. Cl. H05B 3/84; H05B 1/02

(52) U.S. Cl. CPC H05B 3/84; H05B 1/0236

(57) ABSTRACT

Systems, methods, and devices for resistivity optimization of an electro-conductive coated or filmed surface for de-icing and defogging is provided. The device comprises: a delivery unit providing an electrical current to the electro-conductive coated or filmed surface; a patterned track applied on the electro-conductively coated or filmed surface, the patterned track inhibiting the electric current flow across the patterned track, wherein the electric current bypasses the patterned track while traversing through the electro-conductive coated or filmed surface; and a processor configured to control supply of the electrical current. The device further comprises a receiving unit configured to receive the electric current traversing through the electro-conductive coated or filmed surface.

### TECHNICAL FIELD

The following relates generally to systems, methods, and devices for surface deicing and defogging, and more particularly to systems, methods, and devices for optimization of surface resistivity for deicing and defogging.

### INTRODUCTION

Surfaces such as windshields in automobiles are susceptible to ice formation when exposed to freezing temperatures. Moisture often deposits on the exposed surfaces from sources such as precipitation, sleet, or snow. With an overall drop in the ambient temperature, the surface temperature may fall below the freezing point of water. As the moisture contacts the exposed surface, a layer of frost, slush, or ice may form on the surface. Multiple denser layers of ice may form with additional deposits of moisture or with multiple cycles of warming and cooling resulting in partial melting and refreezing. As a result, a harder and more compact layer of ice may accumulate on the cold surface reducing visibility through the windshield, making it hard to remove.

Accumulation of ice on the surfaces such as windshields poses challenges related to visibility and safety. Ice deposit on automobile windshields or side mirrors often obstructs the view of the drivers, creating unsafe driving conditions. Ice also restricts the windshield wipers from operating and may damage the wiper blade or motors.

Various methods and systems are used for removing ice from the surfaces. The electric windshield heating systems are effective for defogging and deicing operations. The electric systems include heating elements such as transparent electric conductive coatings embedded within the windshields that generate heat on the transmission of electric current. The heating elements may include other transparent conductive materials such as a thin wire. The heating elements may be connected to the vehicle's electrical system using busbars. Switches or dedicated processing systems may be used to control the flow of electricity to the busbars and the heating elements.

The conductive materials such as electric coatings or films work on the principle of resistive heating. To illustrate, the conductive coatings applied on windshields possess resistivity such that the electric current passing through the materials encounters resistance resulting in the generation of heat. The most commonly used materials include indium Fluorine-doped Tin Oxide (FTO), Indium Tin Oxide (ITO), carbon nanotubes, and silver for their resistive and conductive properties.

Optimization of resistivity in the conductive materials or the heating elements is a key parameter for determining the overall efficiency, reliability, and safety of electric windshield heating systems. The presence of resistivity in heating elements governs the amount of electric power that is opposed when the current flows through the heating elements resulting in the generation of heating. This heat is critical for melting the immediate layer of ice or frost deposited on exposed surfaces such as windshields and automobile glass windows.

Heating elements with low resistivity may generate low heat values, insufficient for melting the ice accumulated on the surfaces. The low-resistivity heating elements may also draw excessive current leading to an overload of the vehicle's electrical system. The flow of excessive current through heating elements with low resistivity also poses safety risks in the event of exposure to the heating elements by humans. For example, Low-E Glass includes coatings of Triple Silver MSVD (Magnetron Sputter Vacuum Deposition) material to reduce the transmission of ultraviolet (UV) light through the glass. However, the low resistivity provided by the silver coating reduces the heating efficiency of an electric windshield heating system when used on windshields with Low-E glass.

Therefore, optimization of resistivity in the heating elements and coatings, especially for coatings with low resistivity, is necessary to ensure efficient performance of the electric deicing and defogging systems.

Accordingly, systems, methods, and devices are desired that overcome one or more disadvantages associated with existing surface deicing systems and particularly towards optimizing the resistivity of the surface deicing and defogging systems.

### SUMMARY

A device for resistivity optimization of an electro-conductive coated or filmed surface for de-icing and defogging is provided. The device comprises a delivery unit providing an electrical current to the electro-conductive coated or filmed surface; an patterned track applied on the electro-conductively coated or filmed surface, the patterned track inhibiting the electrical current flow across the patterned track, wherein the electrical current bypasses the patterned track while traversing through the electro-conductive coated surface; and a processor configured to control supply of the electrical current.

The device may further comprise a receiving unit configured to receive the electrical current traversing through the electro-conductive coated or filmed surface.

In an embodiment, the patterned track creates a separate section within the electro-conductively coated or filmed surface, wherein the patterned track inhibits electrical connectivity between the separate section and a remaining section of electro-conductively coated or filmed surface.

In an embodiment, the delivery unit and the receiving unit are electric connectors that are electrically linked to a plurality of busbars.

In an embodiment, the electrical current is a pulse electro-thermal electrical current.

In an embodiment, a plurality of incomplete patterned tracks are provided on the electro-conductive coated or filmed surface to create a plurality of connected sections on the electro-conductive coated or filmed surface.

In an embodiment, a plurality of complete patterned tracks are provided on the electro-conductive coated or filmed surface to create a plurality of independent sections on the electro-conductive coated or filmed surface.

In an embodiment, the plurality of independent sections are electrically connected by means of an additional connector.

The device further may comprise a plurality of capacitors for detecting substance accumulation on a surface section, wherein the plurality of capacitors are connected to a plurality of sections on the electro-conductive coated or filmed surface created by the patterned track, and wherein the plurality of sections perform as electrodes for the plurality of capacitors.

In an embodiment, the electro-conductive coated or filmed surface includes a Low-Emissivity glass, wherein the Low-Emissivity glass includes a silver coating for inhibiting ultraviolet rays.

A system for resistivity optimization of an electro-conductive coated or filmed surface for de-icing and defogging is provided. The system comprises a delivery unit providing the electrical current to the electro-conductive coated or filmed surface; an patterned track applied on the electro-conductively coated or filmed surface, the patterned track inhibiting the electrical current flow across the patterned track, wherein the electrical current bypasses the patterned track while traversing through the electro-conductive coated or filmed surface; wherein the patterned track creates a plurality of unconnected sections on the electro-conductively coated or filmed surface; a plurality of connectors providing differential electrical power to each of the plurality of unconnected sections; and a processor configured to control supply of the electrical current.

In an embodiment, plurality of connectors are electrically linked to a plurality of busbars.

The system may comprises a plurality of capacitors for detecting substance accumulation on the electro-conductive coated or filmed surface, wherein the plurality of capacitors are connected to the plurality of unconnected sections, and wherein the plurality of unconnected sections perform as electrodes for the plurality of capacitors.

A method for resistivity optimization of an electro-conductive coated or filmed surface to deicing and defogging is provided. The method comprises releasing an electrical current by an electrical current source controlled a processor; providing the electrical current to the electro-conductive coated or filmed surface; and inhibiting an electrical current flow across an patterned track applied on the electro-conductive coating or film, wherein the electrical current bypasses the patterned track while traversing through the electro-conductive coating or film.

The method may further comprise creating a separate section within the electro-conductive coated or filmed surface by means of the patterned track, wherein the patterned track inhibits the electrical connectivity between the separate section and a remaining section of electro-conductively coated or filmed surface.

In an embodiment, the electrical current is a pulse electro-thermal electrical current.

The method may further comprise providing a plurality of incomplete patterned tracks on the electro-conductive coated or filmed surface to create a plurality of connected sections on the electro-conductive coated or filmed surface.

The method may further comprise providing a plurality of complete patterned tracks on the electro-conductive coated or filmed surface to create a plurality of independent sections on the electro-conductive coated or filmed surface.

The method may further comprise connecting the plurality of independent sections by means of an additional connector.

The method may further comprise providing a plurality of capacitors for detecting substance accumulation of a surface section, wherein the plurality of capacitors are connected to a plurality of sections on the electro-conductive coated or filmed surface created by the patterned track, and wherein the plurality of sections perform as electrodes for the plurality of capacitors.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 shows a block diagram illustrating a system in the prior art for deicing and defogging the exposed surfaces, according to an embodiment.

FIG. 2 shows a simplified block diagram of a processing device for surface deicing and defogging, according to an embodiment.

FIG. 3 shows a system with conductive coating and ablated tracks for optimized resistivity, according to an embodiment.

FIG. 4 shows a system with conductive coating and ablated tracks for optimized resistivity, according to an embodiment.

FIG. 5 shows a system with conductive coating and ablated tracks for optimized resistivity, according to an embodiment.

FIG. 6 shows a system with conductive coating and ablated tracks for optimized resistivity, according to an embodiment.

FIG. 7 shows a system with conductive coating and ablated tracks for optimized resistivity, according to an embodiment.

FIG. 8 shows a cross-sectional view of the surface with conductive coating and ablated tracks for optimized resistivity, according to an embodiment.

FIG. 9 is a flow chart of a method of manufacturing the surface with partial conductive coating for sectional heating of a surface, according to an embodiment.

FIG. 10 shows a system with conductive coating and ablated tracks for optimized resistivity, according to an embodiment.

FIG. 11 shows a system with conductive coating and ablated tracks for optimized resistivity, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In this regard, the scope of the present apparatus and processes is not limited to the specific embodiments disclosed herein. Other variations, modifications, and alternatives are also within the scope of the present apparatus and processes. The appended claims are intended to cover such variations, modifications, and alternatives as fall within their true spirit and scope.

Additionally, the present disclosure is not limited to the described methods, systems, devices, and apparatuses, but includes variations, modifications, and other uses thereof as come within the scope of the appended claims. The detailed description of the embodiments and the drawings are illustrative and not restrictive.

For this application, de-icing includes melting, at least a section, of the accumulated ice on the exposed surface. Similarly, defogging or demisting includes the removal, at least a section, of the fog or mist layer on the glass surface. In an embodiment, the operations described for de-icing or defogging include surface heating. The ablated surfaces described in the present disclosure may be configured to provide surface heating or reducing heat loss through the glass.

While ablation is used throughout this disclosure as a non-limiting example of a patterning technique, it will be reasonably understood by those of skill in the art that other patterning techniques may also be used instead of ablation. Thus, in various embodiments, and as used herein, patterning techniques may include ablating, masking, photolithography, etching, any other ways to pattern, or any combinations of the foregoing.

The following relates generally to systems, methods, and devices for surface deicing and defogging, and more particularly to systems, methods, and devices for optimization of surface resistivity for deicing and defogging.

Low-emissivity (Low-E) glass provides a variety of benefits when used in vehicle windshields and windows, including thermal and energy efficiency to prevent heating from escaping or entering the vehicles. Low-emissivity (Low-E) glass includes a coat of a thin layer of metal or metallic oxide, which reflects thermal radiation and inhibits thermal emission, reducing heat transfer. Surfaces using low-emissivity (Low-E) glass provide temperature regulation by reflecting the radiant heat from the sun, thereby keeping the inner temperature cooler. In cold temperatures, low-emissivity (Low-E) glass reduces the heat escaping from the interior, thereby keeping the inner temperature cooler. Further, Low-emissivity (Low-E) glass is beneficial in preventing transmission of harmful ultraviolet (UV) rays and infrared light without compromising the among of visible light, thereby protecting passengers and the interior of the vehicle from UV damage. Overall, the low-emissivity (Low-E) glass improves temperature regulation and energy efficiency and reduces the consumption of resources for heating and cooling the inner conditions of the vehicle. For similar properties of reflecting ultraviolet and infrared light, Low-E glass is also used in building windows and doors.

Low-E glass includes low-emissivity coatings that reflect ultraviolet rays and infrared energy. Processes such as pyrolytic or hard coating methods and Magnetron Sputter Vacuum Deposition (MSVD) may be used for applying low-emissivity coatings. When used in windshield glass, the low emissivity coating may be applied on either the glass surface facing the interior of the vehicle, or the surface facing the exterior of the vehicle. In an embodiment, the low emissivity coating is applied at the interface between a glass layer and the Polyvinyl Butyral (PVB) interlayer used in the windshields. Commonly used materials in low emissivity coatings include Pyrolytic, Double Silver Magnetron Sputter Vacuum Deposition (MSVD), and Triple Silver Magnetron Sputter Vacuum Deposition (MSVD).

Electric windshield deicing systems work on the principle of resistive heating, where an electric current is passed through a transparent electro-conductive coating in the windshield glass. The resistive heating is caused due to passage of the electric current, leading to the melting, of at least a section of the ice accumulation on the exterior windshield surface. Electric windshield defogging systems operate on a similar principle, where the transparent electro-conductive coating in the windshield is applied close to the glass layer exposed to the interior of the vehicle. The heat generated due to resistive heating at the inner glass layer increases the glass surface temperature above the dew point and hence defogs the surface.

However, if the coatings provide low resistivity and or possess low resistive heating properties, a significantly higher electric current is required to generate the heat necessary to melt the accumulated ice or defog the inner glass surface. This may result in increased energy demand and additional strain on the vehicle's electrical system. When applied to an electric vehicle, this may reduce the vehicle's overall range. Further, potential safety concerns may arise as the low resistivity and high current may cause short circuits. Additionally, if the conductive coating is exposed due to a crack or damage to the windshield, it may potentially pose an electrical hazard for humans who may touch the coating accidentally.

The coatings used in Low-E glass, including Double Silver Magnetron Sputter Vacuum Deposition (MSVD), or a Triple Silver Magnetron Sputter Vacuum Deposition (MSVD), while providing electro-conductive properties, also exhibit low resistivity making them difficult to use with electric windshield deicing and defogging systems.

Therefore, optimization of resistivity of the low-emissivity (Low-E) glass or similar surfaces with coatings possessing low resistivity properties improves deicing and defogging functions when used with electric deicing and defogging systems. Further, the resistive heating elements may need to be evenly applied for uniform heating for deicing and defogging operations. Therefore, designing a low-emissivity (Low-E) glass windshield and glass panes with an integrated deicing and defogging system balances heat reflectivity, uniform electrical conductivity, energy efficiency, and safety.

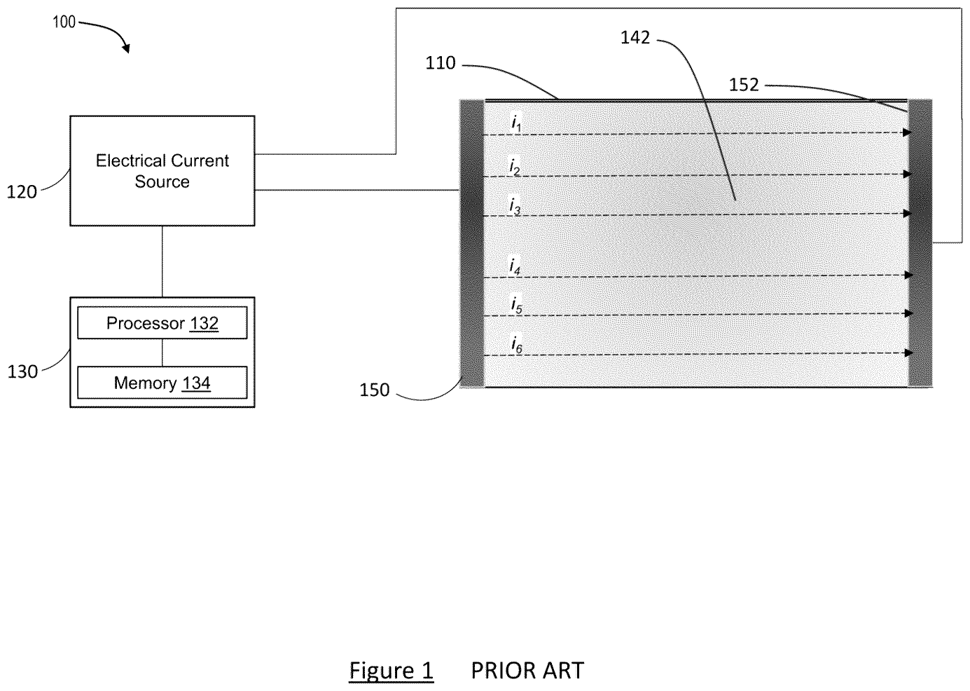

FIG. 1 shows a block diagram illustrating a system 100 in the prior art for deicing and defogging the exposed surfaces.

The system is configured to remove ice from the surface 110. The surface 110 may include vehicle windshields, rear vehicle windows, aircraft windshields, and glass or similar material used in buildings.

The system includes an electrical current source 120. The electrical current source 120 may be connected to a vehicle battery.

The electrical current source 120 is further connected to a processing unit 130. The processing unit includes a processor 132 and memory 134.

The surface 110 includes a transparent electro-conductive coating 142. The connectors 150 and 152 create a potential difference leading to the current flow as indicated in i₁ to i₆. The electrical current source 120 may provide pulsed electrothermal deicing (PETD) current to the connectors 150 and 152, resulting in flow of electric current and generation of resistive heating to the surface 110 for de-icing. In an embodiment, the electrical current source includes a direct current (DC). Other forms of electric current provided by the electrical current source includes alternating current (AC) for conveniently stepping up or reducing the voltage power. In an embodiment, the electrical current source includes a plurality of current types, with application of a direct current (DC) first. The preferred resistance properties in heating track 140 ranges between 1 ohm and 100 ohms per square foot.

The system may include an impedance meter (not shown) to provide a capacitance level based on the phase difference between the AC excitation signal provided by the AC excitation source (not shown) and the induced current. The memory 134 may also store de-icing conditions based on the capacitance level or the impedance level corresponding to the detected thickness of the ice accumulation. When the ice accumulation exceeds a threshold thickness, the de-icing condition may be satisfied and the processor 132 may execute instructions to activate the electric current source 120 for providing the electric current to the heating track 140 for deicing. The electric current source 120 may be deactivated when the ice accumulation and thickness fall below the threshold thickness corresponding to the de-icing conditions.

The system may also include a temperature sensor (not shown) connected to the surface 110 and the processor 132. The temperature sensor may detect the temperature of the surface to at least partly determine whether de-icing conditions are present, and the nature and amount of the ice accumulation. When the ice accumulation exceeds a temperature threshold, the de-icing condition may be satisfied and the processor 132 may execute instructions to activate the electric current source 120 for providing the electric current to the heating track 140 for deicing. The electric current source 120 may be deactivated when the ice accumulation and temperature fall below the temperature threshold corresponding to the de-icing conditions.

The system may also detect the dielectric permittivity of the accumulation on the surface to detect whether the accumulation includes water, ice, or snow. As a result, the corresponding electric current level may be released by the electric current source 120 to remove the accumulation on surface 110.

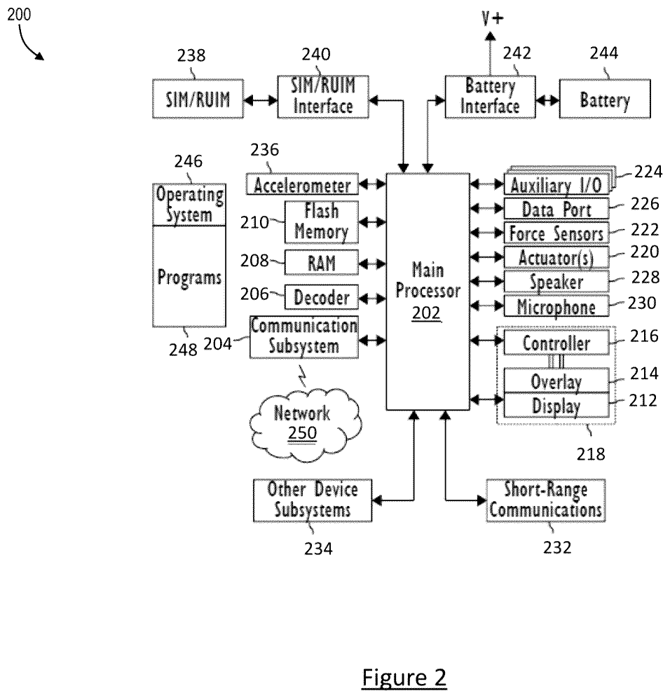

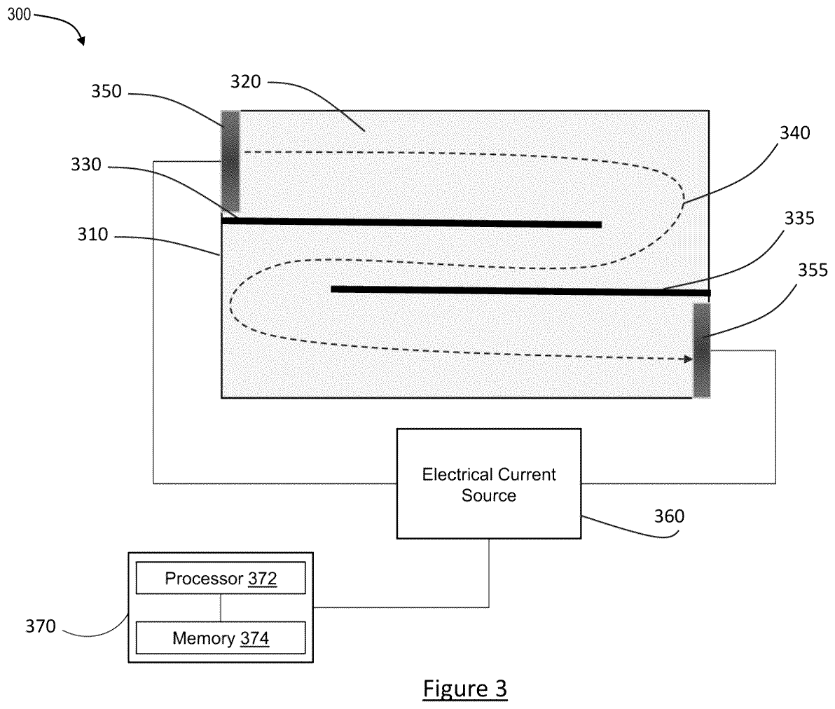

FIG. 2 shows a simplified block diagram of components of a processing device 200 for surface deicing and defogging connected to the windshield with optimized resistivity, according to an embodiment. In an embodiment, the processing device is the processing unit 370 of FIG. 3. The device 200 includes a processor 202 that controls the operations of the device 200. Communication functions, including data communications, voice communications, or both may be performed through a communication subsystem 204. The communication subsystem 204 may receive messages from, and send messages to, a wireless network 250. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces. The processor 202 is configured to interact with the heating elements and icing detector units described herein.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

FIG. 3 shows a system 300 with conductive coating and ablated tracks for optimized resistivity, according to an embodiment.

The surface 310 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 3, the surface 310 is a windshield surface.

In an embodiment, the system includes an electrical current source 360. The electrical current source 360 may be connected to a vehicle battery.

In an embodiment, the electrical current source 360 is further connected to a processing unit 370. The processing unit includes a processor 372 and memory 374.

In an embodiment, the electrical current source 360 is connected to a switch operated by a climate control unit of a vehicle (not shown).

The system 300 includes optically-transparent electrically-conductive coating (OTEC) material 320 placed on the surface 310. The optically-transparent electrically-conductive coating (OTEC) material 320 may be placed at the inner cross-section layer of the surface 310. The optically-transparent electrically-conductive coating (OTEC) material 320 includes a coating or a film, when applied to the surface 310, allows electricity to pass through, at least a section, of the coating on the surface 310. In an embodiment, the coating, when applied to the surface 310, allows the visible light to completely pass through the surface 310. In an embodiment, the coating, when applied to the surface 310, allows the light to pass, at least partially, through the surface 310. In an embodiment, the optically-transparent electrically-conductive coating (OTEC) material 320 is applied on the whole of the surface 310. In an embodiment, the optically-transparent electrically-conductive coating (OTEC) material 320 is applied on, at least a section, of the surface 310. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated tracks 330 and 335 include sections of the electro-conductive coating removed from the surface 310. The ablated tracks 330 and 335 are provided to inhibit the flow of the electric current through the ablated sections, while maintaining electrical connection within the connected sections of the coating 320. In an embodiment, the coating 320 is completely removed at the ablated tracks 330 and 335 to inhibit the flow of electricity through the ablated tracks. In an embodiment, the ablated tracks are provided as incomplete cuts of the coating 320 to allow the electric current to pass along or at a distance from the edges of the ablated tracks, while passing through the coating 320 on the surface 310, and completing a circuit by exiting the surface 310 from an outlet connector 355, also referred to as a second connector. As the electro-conductive coating is removed at the ablated tracks 330 and 335, when the electric current is introduced into the surface 310, the current flows through the coating bypassing the ablated tracks 330 and 355, traversing a longer distance compared to a coating where no ablation is provided. According to an embodiment, the path of the current flow 340 indicates an “S” shape, passing through the coating 320 while avoiding the ablated tracks. According to an embodiment, the ablated tracks may have different shapes, instead of straight lines. According to an embodiment, the coating 320 includes multiple ablated tracks, including more than two ablated tracks. By providing additional ablated tracks, the distance of electric flow within the coating 320 is increased, thereby increasing overall resistance. Further, the same coating 320 may have ablated tracks of different shapes or configurations.

In an embodiment, a distal section of the ablated track is shaped as either a simple straight cut, a half-circle, or a large circle to reduce the thermal stress created by the concentration of current density around the ablated corners. The distal section of the ablated track refers to the section on the ablated track extending into the surface 310, in a direction opposite to the section of ablated track connected to the edge of the surface 310.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

According to an embodiment, laser ablation is used to create ablated tracks 330 and 335 on the electro-conductive coating. The process may include identifying the parameters of the coating to be removed including thickness and length of the tracks. A laser power source is directed to the coating to cause rapid heating and vaporization of the coating along the intended ablated track from the surface 310. The intensity and duration of the laser pulses may be adjusted to remove thicker layers of electro-conductive coating. In an embodiment, to create non-electricity conductive tracks within the coating 320, a mask is placed on the intended sections of the surface 310 before the coating process. As no coating 320 is provided on the masked surface, the non-electricity conductive tracks are formed on the coating 320.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 350 and 355 are connected to surface 310 to apply the electric current to the coating 320 on the surface 310. In an embodiment, the connectors 350 and 355 are connected to the surface 310 through respective busbars (not shown). In an embodiment, the first busbar (not shown) is placed at the top left or top right edge of the windshield surface 310 and connected to electric source 360 through the first connector 350, also referred as an inlet connector as shown in FIG. 3. The top edge may refer to the area located at the uppermost corner on the driver's side or the front passenger's side of the vehicle's windshield. In an embodiment, the inlet connector 350 and outlet connector 355 are placed at any locations on the surface 310 to allow pre-determined electrical current path within the coating 320.

In an embodiment, the electric current is supplied to the electrically-conductive coating 320 by the first busbar. The first busbar is electrically connected to the electrical current source 360. The first busbar may be composed of either of a metallic aluminum or copper strip or silver paste. In an embodiment, the first busbar receives electrical current from the electrical current source 360 and distributes the electrical current into the surface 310 through the coating 320. As the electrical power traverses through the conductive material of the coating 320, avoiding the ablated tracks 330 and 335, heat is generated due to the resistivity of the electrically-conductive coating 320, resulting in the deicing of, at least a section, of the accumulated ice on the surface 310. The electric current path 340 follows a pattern in the coating 320 avoiding the ablated tracks 330 and 335 and covering a longer distance through the coating 320 on the surface 310. In an embodiment, similar application of heat on the surface results in defogging of, at least a section of, the fog collected on the surface 310. The current returns to the power source 360 through the second busbar connected to the second connector 355 to complete the circuit.

In an embodiment, the electric current is supplied to the coating 320 by the first connector 350 directly without a first busbar. In an embodiment, the electric current exits the coating 320 through the second connector 355 without a second busbar. In an embodiment, the connectors 350 and 355 include a respective connecting means to electrically connect the electrical current source 360 to the coating 320. Examples of connectors include one or more of conductive clips, spring-loaded connectors, busbars, tab connectors, or wires. In an embodiment, the connectors 350 and 355 are connected to the electrical current source 360 through an electrically conductive means such as a wire.

According to an embodiment, the electrical current source 360 provides pulsed electrothermal deicing (PETD) current to the connectors 350 and 355 to provide heat to the surface 310 for de-icing. In an embodiment, an alternative electrical current receiving unit is utilized instead of the busbars.

In an embodiment, the electrical current source 360 provides constant electric current at any frequency. In an embodiment, the electrical current source 360 provides electric current at a plurality of frequencies, including a high frequency current.

By providing a longer distance for the electric current to traverse within coating 320 on the surface 310, overall resistance is increased for coatings, including coatings composed of materials with low resistivity such as silver coatings used in Low-E glass. As a result, longer heating patterns within the surface 310 are formed through the multiple connected sections of optically-transparent electrically-conductive coatings (OTEC material) within the surface. This may provide uniform distribution of heat across the surface 310. According to an embodiment, a variety of ablated tracks may be designed to focus heat on specific regions of the windshield.

In an embodiment, the processor 372 is configured to control the electrical current source's distribution of electrical current including the time and voltage of the electrical current. The processor 372 may be configured to execute pre-determined heating patterns including the time and voltage to implement the heating patterns. Further, the processor 372 may be configured to collect capacitance value of a plurality of sections within the coating 320 to determine the volume of accumulated ice on the sections. The memory 374 may be configured to store instructions associated with the pre-determined heating patterns.

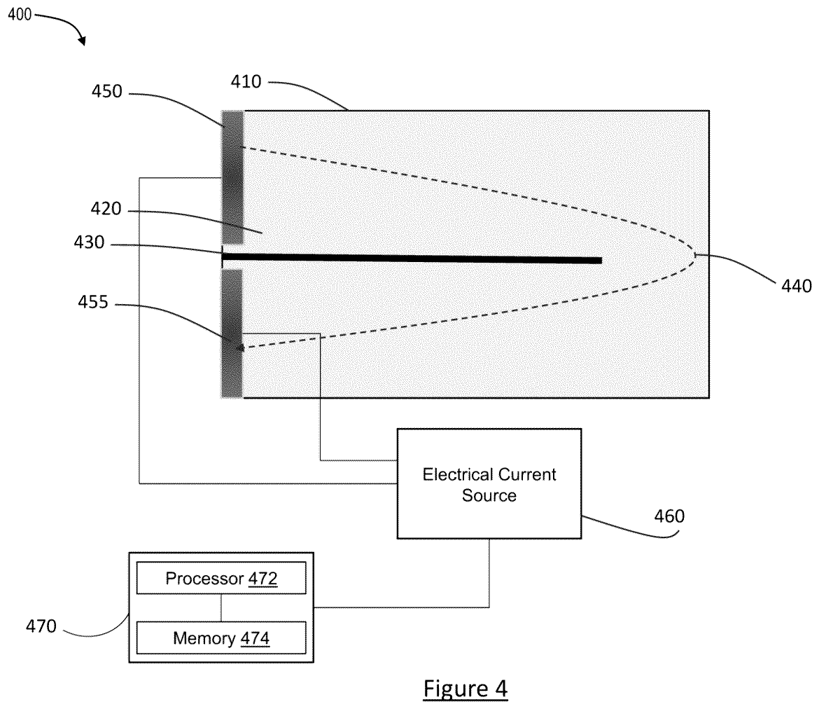

FIG. 4 shows a system 400 with conductive coating and ablated tracks for optimized resistivity, according to an embodiment.

The surface 410 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals;

FIG. 4, surface 410 is a windshield surface.

In an embodiment, the system includes an electrical current source 460. The electrical current source 460 may be connected to a vehicle battery.

In an embodiment, the electrical current source 460 is further connected to a processing unit 470. The processing unit includes a processor 472 and memory 474.

In an embodiment, the electrical current source 460 is connected to a switch operated by a climate control unit of a vehicle (not shown).

The system 400 includes optically-transparent electrically-conductive coating (OTEC) material 420 placed on the surface 410. The optically-transparent electrically-conductive coating (OTEC) material 420 may be placed at the inner cross-section layer of the surface 410. The optically-transparent electrically-conductive coating (OTEC) material 420 includes a coating or a film, when applied to the surface 410, allows electricity to pass through, at least a section, of the coating on the surface 410. In an embodiment, the coating, when applied to the surface 410, allows the visible light to completely pass through the surface 410. In an embodiment, the coating, when applied to the surface 410, allows the light to pass, at least partially, through the surface 410. In an embodiment, the optically-transparent electrically-conductive coating (OTEC) material 420 is applied on the whole of the surface 410. In an embodiment, the optically-transparent electrically-conductive coating (OTEC) material 420 is applied on, at least a section, of the surface 410. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated track 430 includes a section of the electro-conductive coating removed from the surface 410. The ablated track 430 is provided to inhibit the flow of the electric current through the ablated section, while maintaining electrical connection throughout the connected sections within the coating 420. In an embodiment, the coating 420 is completely removed at the ablated track 430 to inhibit the flow of electricity through the ablated track. As the electro-conductive coating is removed at the ablated track 430, when the electric current is introduced into the surface 410, the current flows through the coating bypassing the ablated track 430, traversing a longer distance compared to a coating where no ablation is provided. In an embodiment, the ablated track 430 is provided as incomplete cut of the coating 420 to allow the electric current to pass along or at a distance from the edges of the ablated track 430, while passing through the coating 420 on the surface 410, and completing a circuit by exiting the surface 410 from an outlet connector 455, also referred to as a second connector. According to an embodiment, the path of the current flow 440 indicates a “U” shape, passing through the coating 420 while avoiding the ablated track. According to an embodiment, the ablated track may have different shapes, instead of straight lines. According to an embodiment, the coating 420 includes multiple ablated tracks, including more than one ablated track. By providing additional ablated tracks, the distance of electric flow within the coating 420 is increased, thereby increasing overall resistance.

In an embodiment, a distal section of the ablated track is shaped as either a simple straight cut, a half-circle, or a large circle to reduce the thermal stress created by the concentration of current density around the ablated corners. The distal section of the ablated track refers to the section on the ablated track extending into the surface 410, in a direction opposite to the section of ablated track connected to the edge of the surface 410.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

According to an embodiment, laser ablation is used to create ablated track 430 on the electro-conductive coating. The process may include identifying parameters of coating to be removed including thickness and length of the track. A laser power source is directed to the coating to cause rapid heating and vaporization of the coating along the intended ablated track from the surface 410. The intensity and duration of the laser pulses may be adjusted to remove thicker layers of electro-conductive coating. In an embodiment, to create non-electricity conductive tracks within the coating 420, a mask is placed on the intended sections of the surface 410 before the coating process. As no coating 420 is provided on the masked surface, the non-electricity conductive tracks are formed on the coating 420.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 450 and 455 are connected to the surface 410 to apply the electric current to the coating 420 on the surface 410. In an embodiment, the connectors 450 and 455 are connected to the surface 410 through respective busbars (not shown). In an embodiment, the first busbar (not shown) is placed at the top left or top right edge of the windshield surface 410 and connected to the first connector 450, also referred as an inlet connector. The top edge may refer to the area located at the uppermost corner on the driver's side or the front passenger's side of the vehicle's windshield. In an embodiment, the inlet connector 450 and outlet connector 455 are placed at any locations on the surface 410 to allow pre-determined electrical current path within the coating 420.

In an embodiment, the electric current is supplied to the electrically-conductive coating 420 by the first busbar. The first busbar is electrically connected to the electrical current source 460. The first busbar may be composed of either of a metallic aluminum or copper strip or silver paste. In an embodiment, the first busbar receives electrical current from the electrical current source 460 and distributes the electrical current into the surface 410 through the electrically-conductive coating 420. As the electrical power traverses through the conductive material of the coating 420, avoiding the ablated track 430, heat is generated due to the resistivity of the electrically-conductive coating 420, resulting in deicing of, at least a section of, the accumulated ice on the surface 410. In an embodiment, similar application of heat on the surface results in defogging of, at least a section of, the fog collected on the surface 410. The electric current path 440 follows a pattern in the coating 420 avoiding the ablated track 430 and covering a longer distance through the electrically-conductive coating 420 on the surface 410. The current returns to the power source 460 through the second busbar connected to the second connector 455 to complete the circuit.

In an embodiment, the electric current is supplied to the coating 420 by the first connector 450 directly without a first busbar. In an embodiment, the electric current exits the coating 420 through the second connector 455 without a second busbar. In an embodiment, the connectors 450 and 455 include a respective connecting means to electrically connect the electrical current source 460 to the coating 420. Examples of connectors include one or more of conductive clips, spring-loaded connectors, busbars, tab connectors, or wires. In an embodiment, the connectors 450 and 455 are connected to the electrical current source 460 through an electrically conductive means such as a wire.

According to an embodiment, the electrical current source 460 provides pulsed electrothermal deicing (PETD) current to the connectors 450 and 455 to provide heat to the electrically-conductive coating 420 for de-icing. In an embodiment, an alternative electrical current receiving unit is utilized instead of the busbars.

In an embodiment, the electrical current source 460 provides constant electric current at any frequency. In an embodiment, the electrical current source 460 provides electric current at a plurality of frequencies, including a high frequency current.

By providing a longer distance for the electric current to traverse within the electrically-conductive coating 420 on the surface 410, overall resistance is increased for the coatings, including coatings composed of materials with low resistivity such as silver coatings used in Low-E glass. As a result, longer heating patterns within the surface 410 are formed through the multiple connected sections of optically-transparent electrically-conductive coatings (OTEC material) within the surface. This may provide uniform distribution of heat across the surface 410. According to an embodiment, a variety of ablated tracks may be designed to focus heat on specific regions of the windshield.

In an embodiment, the processor 472 is configured to control the electrical current source's distribution of electrical current including the time and voltage of the electrical current. The processor 472 may be configured to execute pre-determined heating patterns including the time and voltage to implement the heating patterns. Further, the processor 472 may be configured to collect capacitance value of a plurality of sections within the coating 420 to determine the volume of accumulated ice on the sections. The memory 474 may be configured to store instructions associated with the pre-determined heating patterns.

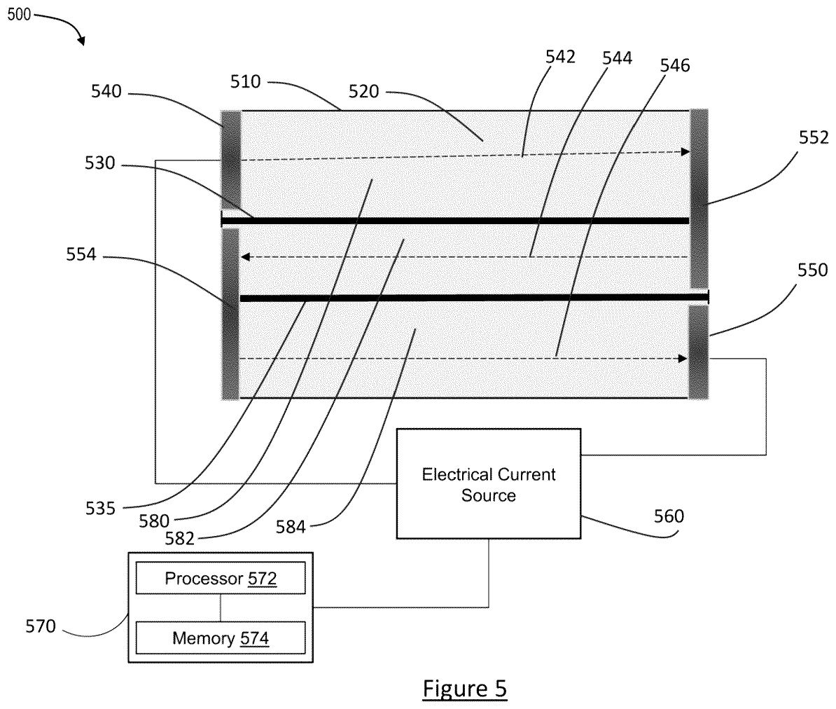

FIG. 5 shows a system 500 with conductive coating and ablated tracks for optimized resistivity, according to an embodiment.

The surface 510 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 5, surface 510 is a windshield surface.

In an embodiment, the system includes an electrical current source 560. The electrical current source 560 may be connected to a vehicle battery.

In an embodiment, the electrical current source 560 is further connected to a processing unit 570. The processing unit includes a processor 572 and memory 574.

In an embodiment, the electrical current source 560 is connected to a switch operated by a climate control unit of a vehicle (not shown).

The system 500 includes optically-transparent electrically-conductive coating (OTEC) material 520 placed on the surface 510. In an embodiment, the optically-transparent electrically-conductive coating (OTEC) material 520 is placed at the inner cross-section layer of the surface 510. The optically-transparent electrically-conductive coating (OTEC) material 520 includes a coating or a film, when applied to the surface 510, allows electricity to pass through, at least a section, of the coating on the surface 510. In an embodiment, the coating, when applied to the surface 510, allows the visible light to completely pass through the surface 510. In an embodiment, the coating, when applied to the surface 510, allows the light to pass, at least partially, through the surface 510. In an embodiment, the optically-transparent electrically-conductive coating (OTEC) material 520 is applied on the whole of the surface 510. In an embodiment, the optically-transparent electrically-conductive coating (OTEC) material 520 is applied on, at least a section, of the surface 510. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated tracks 530 and 535 include sections of the electro-conductive coating removed from the surface 510. The ablated tracks 530 and 535 are provided to inhibit the flow of the electric current through the ablated sections, while maintaining electrical connection within the connected sections of the coating 520 through the additional connectors 552 and 554. In an embodiment, the coating 520 is completely removed at the ablated tracks 530 and 335 to inhibit flow of electricity through the ablated tracks. As the electro-conductive coating is removed at the ablated tracks 530 and 535, when the electric current is introduced into the electro-conductive coating 520, the current flows through the coating bypassing the ablated tracks 530 and 535, traversing a longer distance compared to a coating where no ablation is provided. In an embodiment, the ablated tracks 530 and 535 are formed as complete cuts across the edges of the surface 510 to create three separate sections of the electro-conductive coating 520. The three separate sections are shown as 580, 582, and 584. The first section 580 is electrically connected to the second section 582 by means of a second connector 552. The second section 582 is electrically connected to the third section 584 by means of a third connector 554. In an embodiment, the electrical current is introduced to the surface 510 at the first connector 540, also referred to as the inlet connector, and the electrical current exits the surface 510 at the fourth connector 550. According to an embodiment, the path of the current flow 542, 544, and 546 indicates a longer distance, passing through the electro-conductive coating 520 while avoiding the ablated tracks 530 and 535. According to an embodiment, the ablated tracks may have different shapes, instead of straight lines. According to an embodiment, the coating 520 includes multiple complete ablated tracks, including more than two ablated tracks. By providing additional ablated tracks, multiple sections within coating 520 are formed. The multiple sections are connected to each other by a plurality of connectors. As a result, the distance of electric flow within the coating 520 is increased, thereby increasing overall resistance.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

According to an embodiment, laser ablation is used to create ablated tracks 530 and 535 on the electro-conductive coating. The process may include identifying parameters of coating to be removed including thickness and length of the track. A laser power source is directed to the coating to cause rapid heating and vaporization of the coating along the intended ablated track from the electro-conductive coating 520. The intensity and duration of the laser pulses may be adjusted to remove thicker layers of electro-conductive coating. In an embodiment, to create non-electricity conductive tracks within the coating 520, a mask is placed on the intended sections of the surface 510 before the coating process. As no coating 520 is provided on the masked surface, the non-electricity conductive tracks are formed on the coating 520.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 540 and 550 are connected to the surface 510 to apply the electric current to the coating 520 on the surface 510. In an embodiment, the connectors 540 and 550 are connected to the surface 510 through the respective busbars (not shown). In an embodiment, a first busbar (not shown) is placed at the top left or top right edge of the windshield surface 510 and connected to the first connector 540. The top edge may refer to the area located at the uppermost corner on the driver's side or the front passenger's side of the vehicle's windshield. In an embodiment, additional connectors 552 and 554 are provided. The second connector 552 is provided to electrically connect the section 580 with section 582. The third connector 554 is provided to electrically connect section 582 with section 584. In an embodiment, the inlet connector 540, the outlet connector 550, and the additional connectors are placed at any locations on the surface 510 to allow pre-determined electrical current path within the coating 520.

In an embodiment, the electric current is supplied to the electrically-conductive coating 520 by the first busbar at the first connector 540. The first busbar is electrically connected to the electrical current source 560. The first busbar may be composed of either of a metallic aluminum or copper strip or silver paste. In an embodiment, the first busbar receives electrical current from the electrical current source 560 and distributes the electrical current into the surface 510 through the electrically-conductive coating 520. Specifically, the current is introduced to the first section 580. As the electrical power traverses through the conductive material in the first section 580 while avoiding the ablated track 530, heat is generated due to the resistivity of the electrically-conductive coating, resulting in deicing of, at least a section, of the accumulated ice on the surface 510. In an embodiment, similar application of heat on the surface results in defogging of, at least a section of, the fog collected on the surface 510. The electric current path 542 follows the pattern of the coating in the first section 580 avoiding the ablated track 530 and covering the distance from the first connector 540 to the second connector 552. The second connector 552 introduces the electrical current to the second section 582, wherein the current 544 flows from the second connector 552 to the third connector 554. Thereafter, the third connector 554 introduces the current to section 548, wherein the current 546 flows from third connector 554 to the outlet connector 550. Overall, a longer distance through the electrically-conductive coating 520 is traversed by the electrical current. As the current flows through the respective regions, heat is generated due to the resistivity of the electrically-conductive coating, resulting in deicing of accumulated ice. The current returns to the power source by exiting at the outlet connector 550 to complete the circuit.

In an embodiment, the electric current is supplied to the coating 520 by the inlet connector 540 directly without a first busbar. In an embodiment, the electric current exits the coating 520 through the outlet connector 550 without a second busbar. In an embodiment, the connectors 540 and 550 include a respective connecting means to electrically connect the electrical current source 560 to the coating 520. Examples of connectors include one or more of conductive clips, spring-loaded connectors, busbars, tab connectors, or wires. In an embodiment, the connectors 540 and 550 are connected to the electrical current source 560 through an electrically conductive means such as a wire. In an embodiment, the inlet connector 540, the outlet connector 550, and the additional connectors are accompanied by respective busbars.

According to an embodiment, the electrical current source 560 provides pulsed electrothermal deicing (PETD) current to the connectors 540 and 550 to provide heat to the electrically-conductive coating 520 for de-icing. In an embodiment, an alternative electrical current receiving unit is utilized instead of the busbars.

In an embodiment, the electrical current source 560 provides constant electric current at any frequency. In an embodiment, the electrical current source 560 provides electric current at a plurality of frequencies, including a high frequency current.

By providing a longer distance for the electric current to traverse within the electrically-conductive coating 520 on the surface 510, overall resistance is increased for the coatings, including coatings composed of materials with low resistivity such as silver coatings used in Low-E glass. As a result, longer heating patterns within the surface 510 are formed through the multiple connected sections of optically-transparent electrically-conductive coatings (OTEC material) within the surface. This may provide uniform distribution of heat across the surface 510. According to an embodiment, a variety of ablated tracks may be designed to focus heat on specific regions of the windshield.

In an embodiment, the processor 572 is configured to control the electrical current source's distribution of electrical current including the time and voltage of the electrical current. The processor 572 may be configured to execute pre-determined heating patterns including the time and voltage to implement the heating patterns. Further, the processor 572 may be configured to collect capacitance value of a plurality of sections within the coating 520 to determine the volume of accumulated ice on the sections. The memory 574 may be configured to store instructions associated with the pre-determined heating patterns.

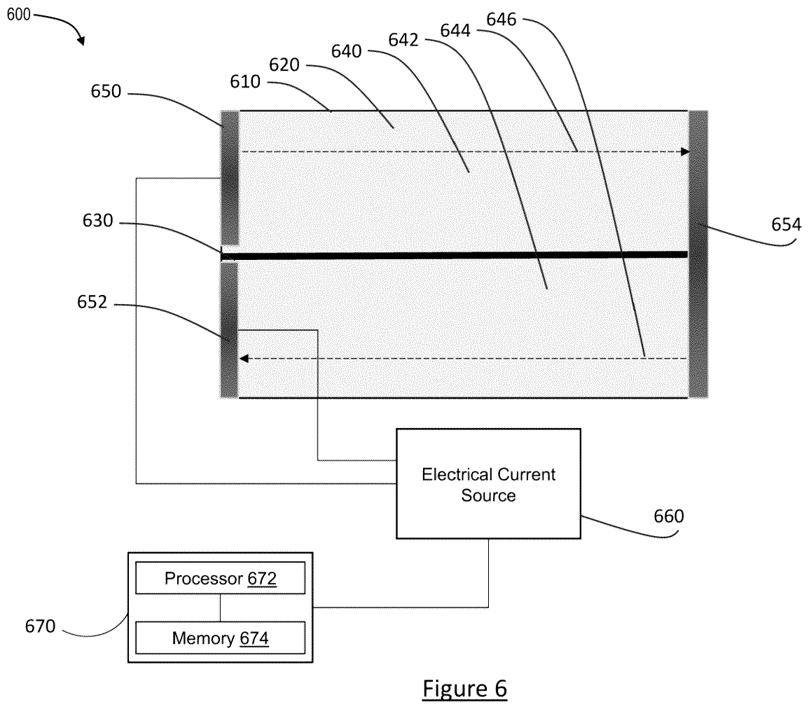

FIG. 6 shows a system 600 with conductive coating and ablated tracks for optimized resistivity, according to an embodiment.

The surface 610 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 6, surface 610 is a windshield surface.

In an embodiment, the system includes an electrical current source 660. The electrical current source 660 may be connected to a vehicle battery.

In an embodiment, the electrical current source 660 is further connected to a processing unit 670. The processing unit includes a processor 672 and memory 674.

In an embodiment, the electrical current source 660 is connected to a switch operated by a climate control unit of a vehicle (not shown).

The system 600 includes optically-transparent electrically-conductive coating (OTEC) material 620 placed on the surface 610. The optically-transparent electrically-conductive coating (OTEC) material 620 may be placed at the inner cross-section layer of the surface 610. The optically-transparent electrically-conductive coating (OTEC) material 620 includes a coating or a film, when applied to the surface 610, allows electricity to pass through, at least a section, of the coating on the surface 610. In an embodiment, the coating, when applied to the surface 610, allows the visible light to completely pass through the surface 610. In an embodiment, the coating, when applied to the surface 610, allows the light to pass, at least partially, through the surface 610. In an embodiment, the optically-transparent electrically-conductive coating (OTEC) material 620 is applied on the whole of the surface 610. In an embodiment, the optically-transparent electrically-conductive coating (OTEC) material 620 is applied on, at least a section, of the surface 610. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated track 630 includes section of the electro-conductive coating removed from the electro-conductive coating 620. The ablated track 630 is provided to inhibit the flow of the electric current through the ablated section, while maintaining electrical connection within the connected sections of the coating 620 through an additional connector 654, also referred to as the second connector. In an embodiment, the coating 620 is completely removed at the ablated track 630 to inhibit the flow of electricity through the ablated tracks. As the electro-conductive coating is removed at the ablated track 630, when the electric current is introduced into the electro-conductive coating 620, the current flows through the coating bypassing the ablated track 630, traversing a longer distance compared to a coating where no ablation is provided. In an embodiment, the ablated track 630 is formed as a complete cut across the edges of the surface 610 to create two separate sections of the electro-conductive coating 620. The two separate sections are shown as 640 and 642. The first section 640 is electrically connected to the second section 642 by means of a second connector 654. In an embodiment, the electrical current is introduced to the surface 610 at the first connector 650, also referred to as the inlet connector, and the electrical current exits the surface 610 at a third connector 652, also referred to as the outlet connector. According to an embodiment, the path of the current flow 644 and 646 indicates a longer distance, passing through the electro-conductive coating 620 while avoiding the ablated track 630. According to an embodiment, the ablated tracks may have different shapes, instead of straight lines. According to an embodiment, coating 620 includes multiple complete ablated tracks across the edges of the surface 610, including more than one ablated track. By providing additional complete ablated tracks, multiple sections may be formed within the coating 620 to increase the distance of the current flow, thereby increasing overall resistance.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

According to an embodiment, laser ablation is used to create ablated track 630 on the electro-conductive coating. The process may include identifying parameters of coating to be removed including thickness and length of the track. A laser power source is directed to the coating to cause rapid heating and vaporization of the coating along the intended ablated track from the electro-conductive coating 630. The intensity and duration of the laser pulses may be adjusted to remove thicker layers of electro-conductive coating. In an embodiment, to create non-electricity conductive tracks within the coating 620, a mask is placed on the intended sections of the surface 610 before the coating process. As no coating 620 is provided on the masked surface, the non-electricity conductive tracks are formed on the coating 620.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 650 and 652 are connected to the surface 610 to apply the electric current to the coating 620 on the surface 610. In an embodiment, the connectors 650 and 652 are connected to the surface 610 through respective busbars (not shown). In an embodiment, the first busbar (not shown) is placed at the top left or top right edge of the windshield surface 610 and connected to the first connector 650. The top edge may refer to the area located at the uppermost corner on the driver's side or the front passenger's side of the vehicle's windshield. In an embodiment, additional connector 654 is provided. The second connector 654 is provided to electrically connect the section 640 with section 642. In an embodiment, the inlet connector 650, the outlet connector 652, and the second connector 654 are placed at any locations on the surface 610 to allow pre-determined electrical current path within the coating 620.

In an embodiment, the electric current is supplied to the electrically-conductive coating 620 by the first busbar at the first connector 650. The first busbar is electrically connected to the electrical current source 660. The first busbar may be composed of either of a metallic aluminum or copper strip or silver paste. In an embodiment, the first busbar receives electrical current from the electrical current source 660 and distributes the electrical current into the surface 610 through the electrically-conductive coating 620. Specifically, the current is introduced to the first section 640. As the electrical power traverses through the conductive material avoiding the ablated track 630, heat is generated due to the resistivity of the electrically-conductive coating, resulting in deicing of, at least a section, of the accumulated ice on the surface 610. In an embodiment, similar application of heat on the surface results in defogging of, at least a section of, the fog collected on the surface 610. The electric current path 644 follows the pattern of the coating in the first section 640 avoiding the ablated track 630 and covering the distance from the first connector 650 to the second connector 654. The second connector 654 introduces the electrical current to the second section 642, wherein the current 646 flows from the second connector 654 to the outlet connector 652. Overall, a longer distance through the electrically-conductive coating 620 is traversed by the electrical current. As the current flows through the respective regions, heat is generated due to the resistivity of the electrically-conductive coating, resulting in deicing of accumulated ice. The current returns to the power source by exiting at the outlet connector 652 to complete the circuit.

In an embodiment, the electric current is supplied to the coating 620 by the inlet connector 650 directly without a first busbar. In an embodiment, the electric current exits the coating 620 through the outlet connector 652 without a second busbar. In an embodiment, the connectors 650 and 652 include a respective connecting means to electrically connect the electrical current source 660 to the coating 620. Examples of connectors include one or more of conductive clips, spring-loaded connectors, busbars, tab connectors, or wires. In an embodiment, the connectors 650 and 652 are connected to the electrical current source 660 through an electrically conductive means such as a wire. In an embodiment, the inlet connector 650, the outlet connector 652, and the second connector 654 are accompanied by respective busbars.

According to an embodiment, the electrical current source 660 provides pulsed electrothermal deicing (PETD) current to the connectors 650 and 652 to provide heat to the electrically-conductive coating 620 for de-icing. In an embodiment, an alternative electrical current receiving unit is utilized instead of the busbars.

In an embodiment, the electrical current source 660 provides constant electric current at any frequency. In an embodiment, the electrical current source 660 provides electric current at a plurality of frequencies, including a high frequency current.

By providing a longer distance for the electric current to traverse within the electrically-conductive coating 620 on the surface 610, overall resistance is increased for the coatings, including coatings composed of materials with low resistivity such as silver coatings used in Low-E glass. As a result, longer heating patterns within the surface 610 are formed through the multiple connected sections of optically-transparent electrically-conductive coatings (OTEC material) within the surface. This may provide uniform distribution of heat across the surface 610. According to an embodiment, a variety of ablated tracks may be designed to focus heat on specific regions of the windshield.

In an embodiment, the processor 672 is configured to control the electrical current source's distribution of electrical current including the time and voltage of the electrical current. The processor 672 may be configured to execute pre-determined heating patterns including the time and voltage to implement the heating patterns. Further, the processor 672 may be configured to collect capacitance value of a plurality of sections within the coating 620 to determine the volume of accumulated ice on the sections. The memory 674 may be configured to store instructions associated with the pre-determined heating patterns.

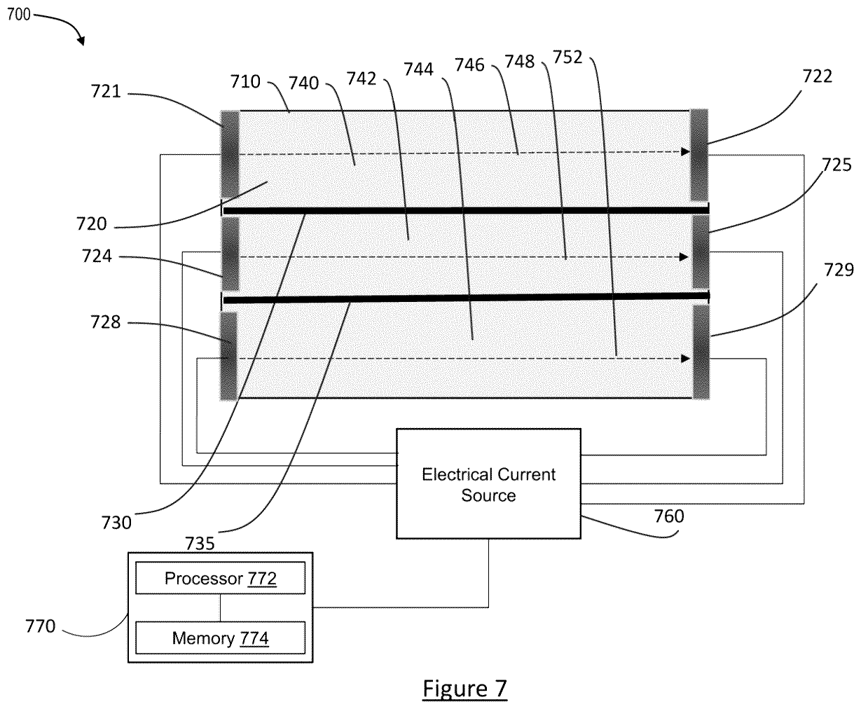

FIG. 7 shows a system 700 with conductive coating and ablated tracks for optimized resistivity, according to an embodiment.

The surface 710 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals;

FIG. 7, surface 710 is a windshield surface.

In an embodiment, the system includes an electrical current source 760. The electrical current source 760 may be connected to a vehicle battery.

In an embodiment, the electrical current source 760 is further connected to a processing unit 770. The processing unit includes a processor 772 and memory 774.

In an embodiment, the electrical current source 760 is connected to a switch operated by a climate control unit of a vehicle (not shown).

The system 700 includes optically-transparent electrically-conductive coating (OTEC) material 720 placed on the surface 710. The optically-transparent electrically-conductive coating (OTEC) material 720 may be placed at the inner cross-section layer of the surface 710. The optically-transparent electrically-conductive coating (OTEC) material 720 includes a coating or a film, when applied to the surface 710, allows electricity to pass through, at least a section, of the coating on the surface 710. In an embodiment, the coating, when applied to the surface 710, allows the visible light to completely pass through the surface 710. In an embodiment, the coating, when applied to the surface 710, allows the light to pass, at least partially, through the surface 710. In an embodiment, the optically-transparent electrically-conductive coating (OTEC) material 720 is applied on the whole of the surface 710. In an embodiment, the optically-transparent electrically-conductive coating (OTEC) material 720 is applied on, at least a section, of the surface 710. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated tracks 730 and 735 include sections of the electro-conductive coating removed from the electro-conductive coating 720. The ablated tracks 730 and 735 are provided to inhibit the flow of the electric current through the ablated sections. In an embodiment, the coating 720 is completely removed at the ablated tracks 730 and 735 to inhibit the flow of electricity through the ablated tracks. As the electro-conductive coating 720 is removed at the ablated tracks 730 and 735, when the electric current is introduced into the electro-conductive coating 720, the current flows through the coating bypassing the ablated tracks 730 and 735. In an embodiment, the ablated tracks 730 and 735 are formed as complete cuts across the edges of the surface 710 to create three separate sections of the electro-conductive coating 720. The three separate sections are shown as 740, 742, and 744.

In an embodiment, the sections 740, 742, and 744 are not electrically inter-connected. Each section is provided with a pair of separate connectors, connected to the electrical current source to provide distinct electrical power such as voltage to the respective section.

According to an embodiment, the overall sum of the path of the current flow 746, 748, and 752 indicates a longer distance, passing through the electro-conductive coating 720 while avoiding the ablated tracks 730 and 735. According to an embodiment, the ablated tracks may have different shapes, instead of straight lines. According to an embodiment, the coating 720 includes multiple complete ablated tracks across the edges of the surface 710, including more than two ablated tracks. By providing additional complete ablated tracks, the multiple sections may be formed within the coating 720 to provide differential current and heating for each section.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

In an embodiment, the coating 720 has two complete cuts to create three separate sections. A plurality of busbars (not shown), are connected to connectors, 721, 722, 724, 725, 728, and 729 to provide an electrical circuit for each section with the electrical power source 760. The first section 740 is connected to the electrical current source 760 using the connectors 721 and 722. In an embodiment, each or both the connectors 721 and 722 are accompanied by respective busbars. The second section 742 is connected to the electrical current source 760 using the connectors 724 and 725. In an embodiment, each or both the connectors 724 and 725 are accompanied by respective busbars. The third section 744 is connected to the electrical current source 760 using the connectors 728 and 729. In an embodiment, each or both the connectors 728 and 729 are accompanied by respective busbars.

In an embodiment, each section is connected directly to the electrical current source 760 using the respective connector without the busbars. The first section 740 is connected to the electrical current source 760 using the connectors 721 and 722. The second section 742 is connected to the electrical current source 760 using the connectors 724 and 725. The third section 744 is connected to the electrical current source 760 using the connectors 728 and 729.

In an embodiment, the connectors 721, 722, 724, 725, 728, and 729 include a connecting means to electrically connect the electrical current source 760 to the respective section. Examples of connectors include one or more of conductive clips, spring-loaded connectors, busbars, tab connectors, or wires. In an embodiment, the connectors are connected to the electrical current source 760 through an electrically conductive means such as a wire. In an embodiment, connectors are accompanied by respective busbars.

The six connectors are connected to the electrical current source 760. In an embodiment, the electrical current source 760 is connected to the different sections 740, 742, and 744 within the coating 720 using a plurality of configurations, including parallel or series or a combination of both.

In an embodiment, the electrical current source 760 and the processing unit 770 are configured to provide differential electrical power to the sections 740, 742, and 744. The differential electrical power value may be determined based on the volume of the accumulated ice or fog. For example, when section 740 has a larger ice accumulation compared to the sections 742 and 744, a higher electrical power may be applied to section 740. The volume of accumulated ice may be calculated based on the capacitance between the sections 740, 742, and 744.

In an embodiment, the electrical current source 760 and the processing unit 770 are used to separate connectors and measure the capacitance between sections 740, 742, and 744 to be able to detect ice or frozen accumulation. This may be performed using three sections 740, 742, and 744 (as shown in the figure) or more if needed.

According to an embodiment, laser ablation is used to create ablated tracks 730 and 735 on the electro-conductive coating. The process may include identifying the parameters of coating to be removed including thickness and length of the track. A laser power source is directed to the coating to cause rapid heating and vaporization of the coating along the intended ablated track from the electro-conductive coating 720. The intensity and duration of the laser pulses may be adjusted to remove thicker layers of electro-conductive coating. In an embodiment, to create non-electricity conductive tracks within the coating 720, a mask is placed on the intended sections of the surface 710 before the coating process. As no coating 720 is provided on the masked surface, the non-electricity conductive tracks are formed on the coating 720.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 721 and 722 are connected to the first section 740 in the conductive coating 720 to apply the electric current from the electrical power source 760. In an embodiment, the connectors 720 and 722 may be connected to respective busbars (not shown).

In an embodiment, connectors 724 and 725 are connected to the second section 742 in the conductive coating 720 to apply the electric current from the electrical power source 760. In an embodiment, the connectors 724 and 725 may be connected to respective busbars (not shown).

In an embodiment, connectors 728 and 729 are connected to the third section 744 in the conductive coating 720 to apply the electric current from the electrical power source 760. In an embodiment, the connectors 728 and 729 may be connected to respective busbars (not shown).

In an embodiment, the electric current is introduced in the first section 740 by the connector 721 connected to the electrical current source 760. As the electrical power traverses through the conductive material avoiding the ablated track 730, heat is generated in the first section 740 due to the resistivity of the electrically-conductive coating, resulting in deicing of, at least a section of, accumulated ice on the surface 710. In an embodiment, similar application of heat on the surface results in defogging of, at least a section of, the fog collected on the surface 710 corresponding to the first section 740. The electric current path 746 follows the pattern of the coating avoiding the ablated track 730 and covering the distance from the connector 721 to the connector 722. The current returns to the power source 760 through the connector 722 to complete the circuit.

In an embodiment, the electric current is introduced in the second section 742 by the connector 724 connected to the electrical current source 760. As the electrical power traverses through the conductive material avoiding the ablated tracks 730 and 735, heat is generated in the second section 742 due to the resistivity of the electrically-conductive coating, resulting in deicing, of at least a section, of the accumulated ice on the surface 710. In an embodiment, similar application of heat on the surface results in defogging of, at least a section of, the fog collected on the surface 710 corresponding to the second section 742. The electric current path 748 follows the pattern of the coating avoiding the ablated tracks 730 and 735 and covering the distance from the connector 724 to the connector 725. The current returns to the power source 760 through the connector 725 to complete the circuit.

In an embodiment, the electric current is introduced in the third section 744 by the connector 728 connected to the electrical current source 760. As the electrical power traverses through the conductive material avoiding the ablated track 735, heat is generated in the third section 744 due to the resistivity of the electrically-conductive coating, resulting in deicing of, at least a section of, the accumulated ice on the surface 710. In an embodiment, similar application of heat on the surface results in defogging of, at least a section of, the fog collected on the surface 710, corresponding to the third section 744. The electric current path 752 follows the pattern of the coating avoiding the ablated track 735 and covering the distance from the connector 728 to the connector 729. The current returns to the power source 760 through the connector 729 to complete the circuit.

By providing a plurality of heating sections separated by ablated tracks 730 and 735, differential heating is applied to each section of the surface corresponding to the heating track. A plurality of designated heating patterns within a surface 710 may be created using multiple busbars and sections of optically-transparent electrically-conductive coatings (OTEC material). This may provide uniform distribution of heat across the surface 710. Alternatively, optimized, and differential distribution of heat according to the ice accumulation at each section may be provided. The current flow path and the corresponding heating track may be designed to focus heat on specific regions of the windshield.

According to an embodiment, the electrical current source 760 provides pulsed electrothermal deicing (PETD) current to the connectors 720, 724, and 728 to provide heat to the electrically-conductive coating 720 for de-icing. In an embodiment, an alternative electrical current receiving unit is utilized instead of the busbars.

In an embodiment, the electrical current source 760 provides constant electric current at any frequency. In an embodiment, the electrical current source 760 provides electric current at a plurality of frequencies, including a high frequency current.

By providing a differential electric current to traverse in different sections within the electrically-conductive coating 720, differential heating patterns may be applied. According to an embodiment, a variety of ablated tracks may be designed to focus heat on specific regions of the windshield.

In an embodiment, the processor 772 is configured to control the electrical current source's distribution of electrical current including the time and voltage of the electrical current. The processor 772 may be configured to execute pre-determined heating patterns including the time and voltage to implement the heating patterns. Further, the processor 772 may be configured to collect capacitance value of a plurality of sections within the coating 720 to determine the volume of accumulated ice on the sections. The memory 774 may be configured to store instructions associated with the pre-determined heating patterns.

In an embodiment, by providing ablation and creating multiple sections within the coating, the sections perform as electrodes for capacitor sensors to detect the accumulated ice. In an embodiment, by providing ablation and creating multiple sections within the coating, the sections perform as resistance heaters to detect the temperature.

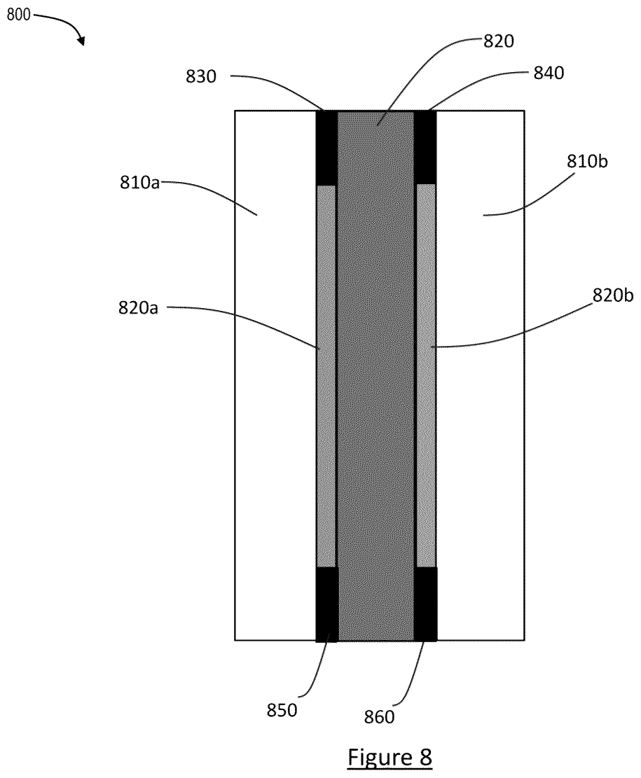

FIG. 8 shows a cross sectional view of the surface with conductive coating and ablated tracks for optimized resistivity, according to an embodiment.

The surface 800 comprises heating elements 820a and 820b. The heating elements surround the central layer 820 of the surface 800. In an embodiment, the central layer is composed of Polyvinyl butyral (PVB) material. For example, the use of PVB material in windshields provides safety and integrity to the windshield in event of damage. Other advantages of the use of PVB includes sound insulation, UV protection, and thermal protection.

In an embodiment, the heating elements 820a and 820b comprise optically-transparent electrically-conductive coatings (OTEC material) to provide resistive heating properties to the surface 800. The heating element 820a interfaces to the outer glass layer 810a. The outer glass layer 810a is exposed to environmental conditions such as rain, snow, ice, and sunlight. The heating element 820b interfaces to the inner glass layer 810b. The inner glass layer 810b is exposed to the inner conditions such as inside of a vehicle, building, or an aircraft.

The heating elements 820a and 820b comprise of ablated optically-transparent electrically-conductive coatings as described in the embodiments above. To illustrate, the heating element 820a includes two ablated tracks as described in FIG. 3.

The heating element 820a provides resistivity heating for de-icing in response to the ice or snow accumulation on the outer surface. The heating element 820a includes an optically-transparent electrically-conductive coating. The coating is connected to two busbars 830 and 850 respectively. In an embodiment, the two busbars 830 and 850 are connected to the respective connectors (not shown). The bus bars 830 and 850 are connected to a power source (not shown), such as the electrical current source described in FIG. 3. In an embodiment, the connectors apply the electrical circuit between the power source and the coating of the heating element 820a without the busbars.

The heating element 820b provides resistive heating for defogging in response to the fogging of inner glass surface. Defogging may also refer to as demisting. The heating element 820b includes an optically-transparent electrically-conductive coating. The coating is connected to two busbars 840 and 860 at each end. In an embodiment, the two busbars 840 and 860 are connected to the respective connectors (not shown). The bus bars 840 and 860 are connected to a power source (not shown), such as the electrical current source described in FIG. 3. In an embodiment, the connectors apply the electrical circuit between the power source and the coating of the heating element 820b without the busbars.

In an embodiment, the surface 800 includes either one of the heating elements 820a or 820b.

In an embodiment, the surface 800 includes both of the heating elements 820a and 820b.

In an embodiment, the four bus bars 830, 840, 850, and 860 are connected to a control module (not shown). The control module is configured to connect different sections within the coatings separated by ablated tracks. The four bus bars 830, 840, 850, and 860 may be connected using a plurality of configurations, including parallel or series or a combination of both. The connection may be performed using a single coating on each surface (shown in the figure) or multiple sections for each coating if needed. In an embodiment, the coatings 820a or 820b could be made from one continuous coating with no ablation or with ablations similar to any of the embodiments described in FIGS. 3 to 7.

In an embodiment, by providing ablation and creating multiple sections within the coating, the sections perform as electrodes for capacitor sensors to detect the accumulated ice. In an embodiment, by providing ablation and creating multiple sections within the coating, the sections perform as resistance heaters to detect the temperature.

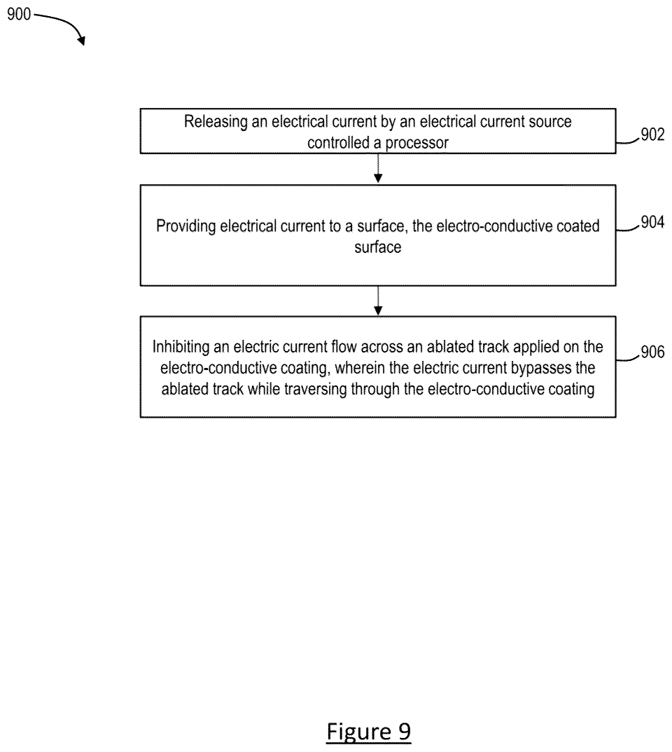

FIG. 9 is a flow chart of a method of manufacturing the surface with partial conductive coating for sectional heating of a surface, according to an embodiment.

At 902, the supply of electrical current is released by an electrical current source controlled a processor.

In an embodiment, the processor includes a processing unit and a memory.

According to an embodiment, the electrical current source provides pulsed electrothermal deicing (PETD) current to the surface to provide heat for de-icing. In an embodiment, an alternative electrical current receiving unit is utilized instead of the busbars.

In an embodiment, the electrical current source provides constant electric current at any frequency. In an embodiment, the electrical current source provides electric current at a plurality of frequencies, including a high frequency current.

In an embodiment, the processor is configured to control the electrical current source's distribution of electrical current including the time and voltage of the electrical current. The processor may be configured to execute pre-determined heating patterns including the time and voltage to implement the heating patterns. Further, the processor may be configured to collect capacitance value of a plurality of sections within the coating to determine the volume of accumulated ice on the sections. The memory may be configured to store instructions associated with the pre-determined heating patterns.

At 904, the electric current is provided to a surface. The surface included an electro-conductive coating.

The surface may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment, the surface is a windshield surface.

In an embodiment, the electro-conductive coating refers to an optically-transparent electrically-conductive coating (OTEC) material placed at the inner cross-section layer of the surface. The optically-transparent electrically-conductive coating (OTEC) material includes a coating or a film, when applied to the surface, allows electricity to pass through, at least a section, of the coating on the surface. In an embodiment, the coating, when applied to the surface, allows the visible light to completely pass through the surface. In an embodiment, the coating, when applied to the surface, allows the light to pass, at least partially, through the surface. In an embodiment, the optically-transparent electrically-conductive coating (OTEC) material is applied on the whole of the surface. In an embodiment, the optically-transparent electrically-conductive coating (OTEC) material is applied on, at least a section, of the surface. Examples of electro-conductive coatings include Double Silver Magnetron Sputter Vacuum Deposition (MSVD) and Triple Silver Magnetron Sputter Vacuum Deposition (MSVD) as used in Low-E glass.

At 906, the electric current flow is inhibited across an ablated track applied on the electro-conductive coating. The electric current bypasses the ablated track while traversing through the electro-conductive coating.

In an embodiment, the ablated track include sections of the electro-conductive coating removed from the surface. In an embodiment, more than one ablated tracks are provided on the electro-conductive coating. The ablated tracks are provided to inhibit the flow of the electric current through the ablated sections, while maintaining electrical connection within the connected sections of the coating on the surface. In an embodiment, the coating is completely removed at the ablated track to inhibit flow of electricity through the ablated tracks. In an embodiment, the ablated tracks are provided as incomplete cuts of the coating to allow the electric current to pass along or at a distance from the edges of the ablated tracks, while passing through the coating on the surface, and completing a circuit by exiting the surface from an outlet connector on the surface.

As the electro-conductive coating is removed at the ablated track, when the electric current is introduced into the surface, the current flows through the coating bypassing the ablated track, traversing a longer distance compared to a coating where no ablation is provided.

According to an embodiment, the coating includes multiple ablated tracks, including more than two ablated tracks. By providing additional ablated tracks, the distance of electric flow within the coating is increased, thereby increasing overall resistance. Further, the same coating may have ablated tracks of different shapes or configurations.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

By providing a longer distance for the electric current to traverse within coating on the surface, overall resistance is increased for coatings, including coatings composed of materials with low resistivity such as silver coatings used in Low-E glass. As a result, longer heating patterns within the surface are formed through the multiple connected sections of optically-transparent electrically-conductive coatings (OTEC material) within the surface. This may provide uniform distribution of heat across the surface. According to an embodiment, a variety of ablated tracks may be designed to focus heat on specific regions of the windshield.

In an embodiment, by providing ablation and creating multiple sections within the coating, the sections perform as electrodes for capacitor sensors to detect the accumulated ice. In an embodiment, by providing ablation and creating multiple sections within the coating, the sections perform as resistance heaters to detect the temperature.

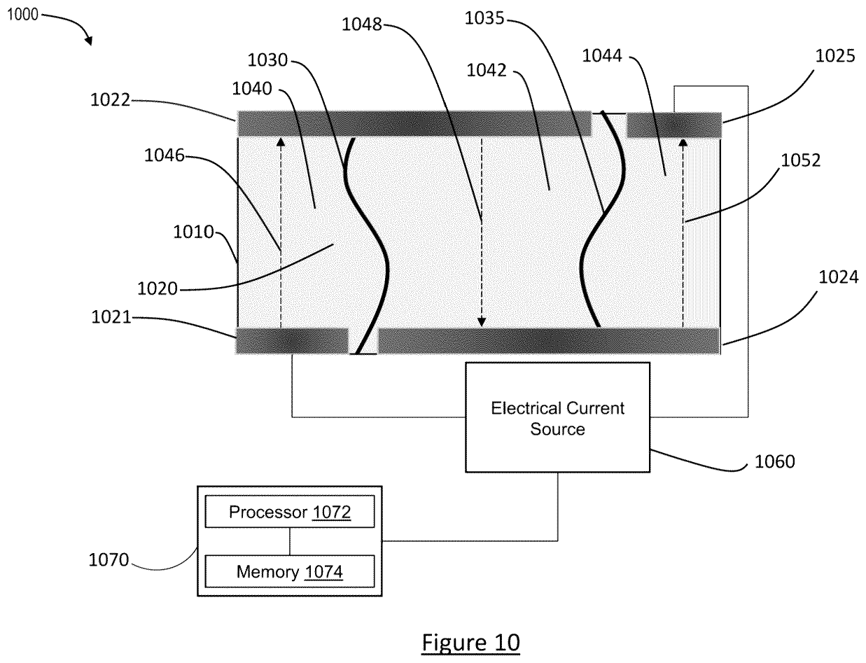

FIG. 10 shows a system 1000 with conductive coating and ablated tracks for optimized resistivity, according to an embodiment.

The surface 1010 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; FIG. 10, surface 1010 is a windshield surface.

In an embodiment, the system includes an electrical current source 1060. The electrical current source 1060 may be connected to a vehicle battery.

In an embodiment, the electrical current source 1060 is further connected to a processing unit 1070. The processing unit includes a processor 1072 and memory 1074.

In an embodiment, the electrical current source 1060 is connected to a switch operated by a climate control unit of a vehicle (not shown).

The system 1000 includes optically-transparent electrically-conductive coating (OTEC) material 1020 placed on the surface 1010. The optically-transparent electrically-conductive coating (OTEC) material 1020 may be placed at the inner cross-section layer of the surface 1010. The optically-transparent electrically-conductive coating (OTEC) material 1020 includes a coating or a film, when applied to the surface 1010, allows electricity to pass through, at least a section, of the coating on the surface 1010. In an embodiment, the coating, when applied to the surface 1010, allows the visible light to completely pass through the surface 1010. In an embodiment, the coating, when applied to the surface 1010, allows the light to pass, at least partially, through the surface 1010. In an embodiment, the optically-transparent electrically-conductive coating (OTEC) material 1020 is applied on the whole of the surface 1010. In an embodiment, the optically-transparent electrically-conductive coating (OTEC) material 1020 is applied on, at least a section, of the surface 1010. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated tracks 1030 and 1035 include sections of the electro-conductive coating removed from the electro-conductive coating 1020. The ablated tracks 1030 and 1035 are provided to inhibit the flow of the electric current through the ablated sections. In an embodiment, the coating 1020 is completely removed at the ablated tracks 1030 and 1035 to inhibit the flow of electricity through the ablated tracks. As the electro-conductive coating 1020 is removed at the ablated tracks 1030 and 1035, when the electric current is introduced into the electro-conductive coating 1020, the current flows through the coating bypassing the ablated tracks 1030 and 1035. In an embodiment, the ablated tracks 1030 and 1035 are formed as complete cuts across the edges of the surface 1010 to create three separate sections of the electro-conductive coating 1020. The three separate sections are shown as 1040, 1042, and 1044.

In an embodiment, the sections 1040, 1042, and 1044 are not electrically inter-connected. Each section has a different shape and a customizable sheet resistance.

According to an embodiment, the overall sum of the path of the current flow 1046, 1048, and 1052 indicates a longer distance, passing through the electro-conductive coating 1020 while avoiding the ablated tracks 1030 and 1035. According to an embodiment, the ablated tracks may have different shapes or curves. According to an embodiment, the coating 1020 includes multiple complete ablated tracks across the edges of the surface 1010, including more than two ablated tracks. By providing additional complete ablated tracks, the multiple sections may be formed within the coating 1020 to provide differential current and heating for each section.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

In an embodiment, patterning is utilized in the optically-transparent electrically-conductive coating (OTEC) material 1020 of each section 1040, 1042, and 1044. By having a pattern in the transparent electro-conductive coating 1020, it becomes possible to adjust the effective sheet resistance and hence can help control the overall total resistance. The patterning also could be combined with ablated tracks 1030 and 1035 to have controlled zones (namely, sections 1040, 1042, and 1044) of different sheet resistances and allow for creating heating zones in the surface 1010. Thus, it becomes possible to change the sheet resistance in different sections of the same surface 1010, (e.g. have one sheet resistance in section 1040 and another sheet resistance in section 1042). This can help control the current density and allow for more or less heating in specific areas.

In an embodiment, patterning techniques may include ablating, masking, photolithography, etching, any other ways to pattern, or any combinations of the foregoing.

Advantageously, having different sections based on patterning could offer more than just the ability to manipulate resistance, as patterning could also be used to guarantee uniform heating in irregular shapes, as well as allow for easier ice/frost detection.

In an embodiment, a plurality of busbars (not shown), are connected to connectors, 1021 and 1025 to provide an electrical circuit.

In an embodiment, the electrical current source 1060 and the processing unit 1070 are configured to provide differential electrical power to the sections 1040, 1042, and 1044. The differential electrical power value may be determined based on the volume of the accumulated ice or fog. For example, when section 1040 has a larger ice accumulation compared to the sections 1042 and 1044, a higher electrical power may be applied to section 1040. The volume of accumulated ice may be calculated based on the capacitance between the sections 1040, 1042, and 1044.

In an embodiment, the electrical current source 1060 and the processing unit 1070 are used to separate connectors and measure the capacitance between sections 1040, 1042, and 1044 to be able to detect ice or frozen accumulation. This may be performed using three sections 1040, 1042, and 1044 (as shown in the figure) or more if needed.

According to an embodiment, laser ablation is used to create ablated tracks 1030 and 1035 on the electro-conductive coating. The process may include identifying the parameters of coating to be removed including thickness and length of the track. A laser power source is directed to the coating to cause rapid heating and vaporization of the coating along the intended ablated track from the electro-conductive coating 1020. The intensity and duration of the laser pulses may be adjusted to remove thicker layers of electro-conductive coating. In an embodiment, to create non-electricity conductive tracks within the coating 1020, a mask is placed on the intended sections of the surface 1010 before the coating process. As no coating 1020 is provided on the masked surface, the non-electricity conductive tracks are formed on the coating 1020.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 1021 and 1022 are connected to the first section 1040 in the conductive coating 1020 to apply the electric current from the electrical power source 1060. In an embodiment, the connectors 1021 and 1022 may be connected to respective busbars (not shown).

In an embodiment, connectors 1022 and 1024 are connected to the second section 1042 in the conductive coating 1020 to apply the electric current from the electrical power source 1060. In an embodiment, the connectors 1022 and 1024 may be connected to respective busbars (not shown).

In an embodiment, connectors 1024 and 1025 are connected to the third section 1044 in the conductive coating 1020 to apply the electric current from the electrical power source 1060. In an embodiment, the connectors 1024 and 1025 may be connected to respective busbars (not shown).

In an embodiment, the electric current is introduced in the first section 1040 by the connector 1021 connected to the electrical current source 1060. As the electrical power traverses through the conductive material avoiding the ablated track 1030, heat is generated in the first section 1040 due to the resistivity of the electrically-conductive coating, resulting in deicing of, at least a section of, accumulated ice on the surface 1010. In an embodiment, similar application of heat on the surface results in defogging of, at least a section of, the fog collected on the surface 1010 corresponding to the first section 1040. The electric current path 1046 follows the pattern of the coating avoiding the ablated track 1030 and covering the distance from the connector 1021 to the connector 1022.

The current is then introduced in the second section 1042 by the connector 1022. As the electrical power traverses through the conductive material avoiding the ablated tracks 1030 and 1035, heat is generated in the second section 1042 due to the resistivity of the electrically-conductive coating, resulting in deicing, of at least a section, of the accumulated ice on the surface 1010. In an embodiment, similar application of heat on the surface results in defogging of, at least a section of, the fog collected on the surface 1010 corresponding to the second section 1042. The electric current path 1048 follows the pattern of the coating avoiding the ablated tracks 1030 and 1035 and covering the distance from the connector 1022 to the connector 1024.

The electric current is then introduced in the third section 1044 by the connector 1024. As the electrical power traverses through the conductive material avoiding the ablated track 1035, heat is generated in the third section 1044 due to the resistivity of the electrically-conductive coating, resulting in deicing of, at least a section of, the accumulated ice on the surface 1010. In an embodiment, similar application of heat on the surface results in defogging of, at least a section of, the fog collected on the surface 1010, corresponding to the third section 1044. The electric current path 1052 follows the pattern of the coating avoiding the ablated track 1035 and covering the distance from the connector 1024 to the connector 1025. The current returns to the power source 1060 through the connector 1025 to complete the circuit.

By providing a plurality of heating sections separated by ablated tracks 1030 and 1035, differential heating is applied to each section of the surface corresponding to the heating track. A plurality of designated heating patterns within a surface 1010 may be created using multiple busbars and sections of optically-transparent electrically-conductive coatings (OTEC material) 1020. This may provide uniform distribution of heat across the surface 1010. Alternatively, optimized, and differential distribution of heat according to the ice accumulation at each section may be provided. The current flow path and the corresponding heating track may be designed to focus heat on specific regions of the windshield.

According to an embodiment, the electrical current source 1060 provides pulsed electrothermal deicing (PETD) current to the connector 1021 to provide heat to the electrically-conductive coating 1020 for de-icing. In an embodiment, an alternative electrical current receiving unit is utilized instead of the busbars.

In an embodiment, the electrical current source 1060 provides constant electric current at any frequency. In an embodiment, the electrical current source 1060 provides electric current at a plurality of frequencies, including a high frequency current.

By providing a differential electric current to traverse in different sections within the electrically-conductive coating 1020, differential heating patterns may be applied. According to an embodiment, a variety of ablated tracks may be designed to focus heat on specific regions of the windshield.

In an embodiment, the processor 1072 is configured to control the electrical current source's distribution of electrical current including the time and voltage of the electrical current. The processor 1072 may be configured to execute pre-determined heating patterns including the time and voltage to implement the heating patterns. Further, the processor 1072 may be configured to collect capacitance value of a plurality of sections within the coating 1020 to determine the volume of accumulated ice on the sections. The memory 1074 may be configured to store instructions associated with the pre-determined heating patterns.

In an embodiment, by providing ablation and creating multiple sections within the coating, the sections perform as electrodes for capacitor sensors to detect the accumulated ice. In an embodiment, by providing ablation and creating multiple sections within the coating, the sections perform as resistance heaters to detect the temperature.

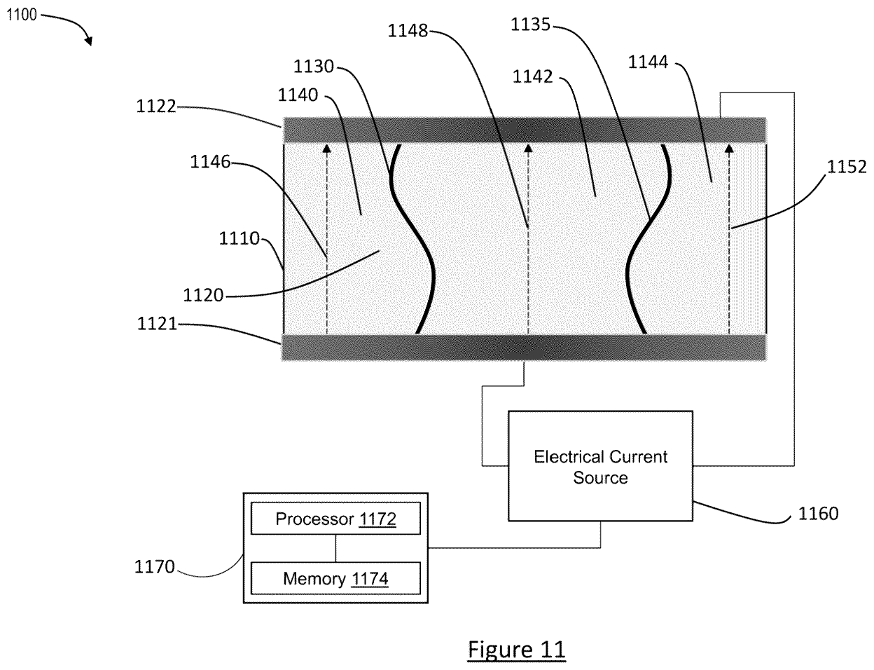

FIG. 11 shows a system 1100 with conductive coating and ablated tracks for optimized resistivity, according to an embodiment.

The surface 1110 may include vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals;

FIG. 11, surface 1110 is a windshield surface.

In an embodiment, the system includes an electrical current source 1160. The electrical current source 1160 may be connected to a vehicle battery.

In an embodiment, the electrical current source 1160 is further connected to a processing unit 1170. The processing unit includes a processor 1172 and memory 1174.

In an embodiment, the electrical current source 1160 is connected to a switch operated by a climate control unit of a vehicle (not shown).

The system 1100 includes optically-transparent electrically-conductive coating (OTEC) material 1120 placed on the surface 1110. The optically-transparent electrically-conductive coating (OTEC) material 1120 may be placed at the inner cross-section layer of the surface 1110. The optically-transparent electrically-conductive coating (OTEC) material 1120 includes a coating or a film, when applied to the surface 1110, allows electricity to pass through, at least a section, of the coating on the surface 1110. In an embodiment, the coating, when applied to the surface 1110, allows the visible light to completely pass through the surface 1110. In an embodiment, the coating, when applied to the surface 1110, allows the light to pass, at least partially, through the surface 1110. In an embodiment, the optically-transparent electrically-conductive coating (OTEC) material 1120 is applied on the whole of the surface 1110. In an embodiment, the optically-transparent electrically-conductive coating (OTEC) material 1120 is applied on, at least a section, of the surface 1110. Examples of electro-conductive coatings include Double Silver Magnetron Sputter Vacuum Deposition (MSVD) and Triple Silver Magnetron Sputter Vacuum Deposition (MSVD) as used in Low-E glass.

The ablated tracks 1130 and 1135 include sections of the electro-conductive coating removed from the electro-conductive coating 1120. The ablated tracks 1130 and 1135 are provided to inhibit the flow of the electric current through the ablated sections. In an embodiment, the coating 1120 is completely removed at the ablated tracks 1130 and 1135 to inhibit the flow of electricity through the ablated tracks. As the electro-conductive coating 1120 is removed at the ablated tracks 1130 and 1135, when the electric current is introduced into the electro-conductive coating 1120, the current flows through the coating bypassing the ablated tracks 1130 and 1135. In an embodiment, the ablated tracks 1130 and 1135 are formed as complete cuts across the edges of the surface 1110 to create three separate sections of the electro-conductive coating 1120. The three separate sections are shown as 1140, 1142, and 1144.

In an embodiment, the sections 1140, 1142, and 1144 are not electrically inter-connected. Each section has a different shape and a customizable sheet resistance.

According to an embodiment, the overall sum of the path of the current flow 1146, 1148, and 1152 indicates a longer distance, passing through the electro-conductive coating 1120 while avoiding the ablated tracks 1130 and 1135. According to an embodiment, the ablated tracks may have different shapes or curves. According to an embodiment, the coating 1120 includes multiple complete ablated tracks across the edges of the surface 1110, including more than two ablated tracks. By providing additional complete ablated tracks, the multiple sections may be formed within the coating 1120 to provide differential current and heating for each section.

In an embodiment, the thickness of the ablated track is optimized. Preferably, the thickness of the ablated track is lesser than the high threshold thickness that may cause thermal stress to build up in the glass surface caused by non-heating of the ablated section on the glass surface. Preferably, the thickness of the ablated track is higher than the low threshold thickness that may cause a short-circuit on the glass surface, especially at high voltages. Preferably, the thickness of the ablated track is at a size to prevent breakdown voltage.

In an embodiment, patterning is utilized in the optically-transparent electrically-conductive coating (OTEC) material 1120 of each section 1140, 1142, and 1144. By having a pattern in the transparent electro-conductive coating 1120, it becomes possible to adjust the effective sheet resistance and hence can help control the overall total resistance. The patterning also could be combined with ablated tracks 1130 and 1135 to have controlled zones (namely, sections 1140, 1142, and 1144) of different sheet resistances and allow for creating heating zones in the surface 1110. Thus, it becomes possible to change the sheet resistance in different sections of the same surface 1110, (e.g. have one sheet resistance in section 1140 and another sheet resistance in section 1142). This can help control the current density and allow for more or less heating in specific areas.

In an embodiment, patterning techniques may include ablating, masking, photolithography, etching, any other ways to pattern, or any combinations of the foregoing.

Advantageously, having different sections based on patterning could offer more than just the ability to manipulate resistance, as patterning could also be used to guarantee uniform heating in irregular shapes, as well as allow for easier ice/frost detection.

In an embodiment, a plurality of busbars (not shown), are connected to connectors, 1121 and 1122 to provide an electrical circuit.

In an embodiment, the electrical current source 1160 and the processing unit 1170 are configured to provide differential electrical power to the sections 1140, 1142, and 1144. The differential electrical power value may be determined based on the volume of the accumulated ice or fog. For example, when section 1140 has a larger ice accumulation compared to the sections 1142 and 1144, a higher electrical power may be applied to section 1140. The volume of accumulated ice may be calculated based on the capacitance between the sections 1140, 1142, and 1144.

In an embodiment, the electrical current source 1160 and the processing unit 1170 are used to separate connectors and measure the capacitance between sections 1140, 1142, and 1144 to be able to detect ice or frozen accumulation. This may be performed using three sections 1140, 1142, and 1144 (as shown in the figure) or more if needed.

According to an embodiment, laser ablation is used to create ablated tracks 1130 and 1135 on the electro-conductive coating. The process may include identifying the parameters of coating to be removed including thickness and length of the track. A laser power source is directed to the coating to cause rapid heating and vaporization of the coating along the intended ablated track from the electro-conductive coating 1120. The intensity and duration of the laser pulses may be adjusted to remove thicker layers of electro-conductive coating. In an embodiment, to create non-electricity conductive tracks within the coating 1120, a mask is placed on the intended sections of the surface 1110 before the coating process. As no coating 1120 is provided on the masked surface, the non-electricity conductive tracks are formed on the coating 1120.

The relationship between resistance and resistivity is provided as follows expression R=ρ*(L/A), where R is the resistance, ρ (rho) is the resistivity of the material, L is the length of the wire, and A is the cross-sectional area of the wire. As the resistivity remains constant for materials such as silver coating, by increasing the length of the current flow, the overall resistance is increased.

In an embodiment, connectors 1121 and 1122 are connected to the first section 1140, the second section 1142, and the third section 1144 in the conductive coating 1120 to apply the electric current from the electrical power source 1160. In an embodiment, the connectors 1121 and 1122 may be connected to respective busbars (not shown).

In an embodiment, the electric current is introduced in the sections 1140, 1142, and 1144 by the connector 1121 connected to the electrical current source 1160. As the electrical power traverses through the conductive material avoiding the ablated track 1130, heat is generated in the sections 1140, 1142, and 1144 due to the resistivity of the electrically-conductive coating, resulting in deicing of, at least a section of, accumulated ice on the surface 1110. In an embodiment, similar application of heat on the surface results in defogging of, at least a section of, the fog collected on the surface 1110 corresponding to the first section 1140. The electric current paths 1146, 1148, and 1152 follow the pattern of the coating avoiding the ablated tracks 1130 and 1135 and covering the distance from the connector 1121 to the connector 1122.

By providing a plurality of heating sections separated by ablated tracks 1130 and 1135, differential heating is applied to each section of the surface corresponding to the heating track. A plurality of designated heating patterns within a surface 1110 may be created using patterning of sections of optically-transparent electrically-conductive coatings (OTEC material) 1120. This may provide uniform distribution of heat across the surface 1110. Alternatively, optimized, and differential distribution of heat according to the ice accumulation at each section may be provided by using different patterning techniques in different sections. The current flow path and the corresponding heating track may be designed to focus heat on specific regions of the windshield.

According to an embodiment, the electrical current source 1160 provides pulsed electrothermal deicing (PETD) current to the connector 1121 to provide heat to the electrically-conductive coating 1120 for de-icing. In an embodiment, an alternative electrical current receiving unit is utilized instead of the busbars.

In an embodiment, the electrical current source 1160 provides constant electric current at any frequency. In an embodiment, the electrical current source 1160 provides electric current at a plurality of frequencies, including a high frequency current.

By providing a differential electric current to traverse in different sections within the electrically-conductive coating 1120, differential heating patterns may be applied. According to an embodiment, a variety of ablated tracks may be designed to focus heat on specific regions of the windshield.

In an embodiment, the processor 1172 is configured to control the electrical current source's distribution of electrical current including the time and voltage of the electrical current. The processor 1172 may be configured to execute pre-determined heating patterns including the time and voltage to implement the heating patterns. Further, the processor 1172 may be configured to collect capacitance value of a plurality of sections within the coating 1120 to determine the volume of accumulated ice on the sections. The memory 1174 may be configured to store instructions associated with the pre-determined heating patterns.

In an embodiment, by providing ablation and creating multiple sections within the coating, the sections perform as electrodes for capacitor sensors to detect the accumulated ice. In an embodiment, by providing ablation and creating multiple sections within the coating, the sections perform as resistance heaters to detect the temperature.

While the above description provides examples of one or more apparatus, methods, or systems, it will be appreciated that other apparatus, methods, or systems may be within the scope of the claims as interpreted by one of skill in the art. Elements of each embodiment may be incorporated into other embodiments, for example, configurations or components discussed in relation to one embodiment, may be applied to other embodiments disclosed herein. Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present invention.

1. A device for resistivity optimization of an electro-conductive coated or filmed surface for de-icing and defogging, the device comprising:
a delivery unit providing an electrical current to the electro-conductive coated or filmed surface;
a patterned track applied on the electro-conductively coated or filmed surface, the patterned track inhibiting the electrical current flow across the patterned track, wherein the electrical current bypasses the patterned track while traversing through the electro-conductive coated or filmed surface; and
a processor configured to control supply of the electrical current.

2. The device of claim 1, wherein the device further comprises a receiving unit configured to receive the electrical current traversing through the electro-conductive coated or filmed surface.

3. The device of claim 2, wherein the patterned track creates a separate section within the electro-conductively coated or filmed surface, wherein the patterned track inhibits electrical connectivity between the separate section and a remaining section of electro-conductively coated or filmed surface.

4. The device of claim 3, wherein the delivery unit and the receiving unit are electric connectors that are electrically linked to a plurality of busbars.

5. The device of claim 4, wherein the electrical current is a pulse electro-thermal electrical current.

6. The device of claim 1, wherein a plurality of incomplete patterned tracks are provided on the electro-conductive coated or filmed surface to create a plurality of connected sections on the electro-conductive coated or filmed surface.

7. The device of claim 1, wherein a plurality of complete patterned tracks are provided on the electro-conductive coated or filmed surface to create a plurality of independent sections on the electro-conductive coated or filmed surface.

8. The device of claim 1, wherein the plurality of independent sections are electrically connected by means of an additional connector.

9. The device of claim 1, wherein the device further comprises a plurality of capacitors for detecting substance accumulation on a surface section, wherein the plurality of capacitors are connected to a plurality of sections on the electro-conductive coated or filmed surface created by the patterned track, and wherein the plurality of sections perform as electrodes for the plurality of capacitors.

10. The device of claim 1, wherein the electro-conductive coated or filmed surface includes a Low-Emissivity glass, wherein the Low-Emissivity glass includes a silver coating or film for inhibiting ultraviolet rays.

11. A system for resistivity optimization of an electro-conductive coated or filmed surface for de-icing and defogging, the system comprising:
a delivery unit providing the electrical current to the electro-conductive coated or filmed surface;
a patterned track applied on the electro-conductively coated or filmed surface, the patterned track inhibiting the electrical current flow across the patterned track, wherein the electrical current bypasses the patterned track while traversing through the electro-conductive coated or filmed surface;
wherein the patterned track creates a plurality of unconnected sections on the electro-conductively coated or filmed surface;
a plurality of connectors providing differential electrical power to each of the plurality of unconnected sections; and
a processor configured to control supply of the electrical current.

12. The system of claim 11, wherein the plurality of connectors are electrically linked to a plurality of busbars.

13. The system of claim 12, wherein the system further comprises a plurality of capacitors for detecting substance accumulation on the electro-conductive coated or filmed surface, wherein the plurality of capacitors are connected to the plurality of unconnected sections, and wherein the plurality of unconnected sections perform as electrodes for the plurality of capacitors.

14. A method for resistivity optimization of an electro-conductive coated or filmed surface to deicing and defogging, the method comprising:
releasing an electrical current by an electrical current source controlled a processor;
providing the electrical current to the electro-conductive coated or filmed surface; and
inhibiting an electrical current flow across a patterned track applied on the electro-conductive coating or film, wherein the electrical current bypasses the patterned track while traversing through the electro-conductive coating or film.

15. The method of claim 14, the method further comprising: creating a separate section within the electro-conductive coated or filmed surface by means of the patterned track, wherein the patterned track inhibits the electrical connectivity between the separate section and a remaining section of electro-conductively coated or filmed surface.

16. The method of claim 15, wherein the electrical current is a pulse electro-thermal electrical current.

17. The method of claim 14, wherein the method further comprises providing a plurality of incomplete patterned tracks on the electro-conductive coated or filmed surface to create a plurality of connected sections on the electro-conductive coated or filmed surface.

18. The method of claim 14, wherein the method further comprises providing a plurality of complete patterned tracks on the electro-conductive coated or filmed surface to create a plurality of independent sections on the electro-conductive coated or filmed surface.

19. The method of claim 18, wherein the method further comprises connecting the plurality of independent sections by means of an additional connector.

20. The method of claim 15, wherein the method further comprises providing a plurality of capacitors for detecting substance accumulation of a surface section, wherein the plurality of capacitors are connected to a plurality of sections on the electro-conductive coated or filmed surface created by the patterned track, and wherein the plurality of sections perform as electrodes for the plurality of capacitors.
